(19) United States
(12) Patent Application Publication
(10) Pub. No.: US 2016/0302416 A1
(43) Pub. Date: Oct. 20, 2016

(54) Methods for Increasing Resistance of Plants to Abiotic Stresses

(71) Applicant: SUNCOR ENERGY INC., Calgary (CA)

(72) Inventors: Michael Fefer, Whitby (CA); Jun Liu, Oakville (CA)

(21) Appl. No.: 15/102,195

(22) PCT Filed: Dec. 5, 2014
(86) PCT No.: PCT/CA2014/051169

§ 371 Date: Jun. 6, 2016

Related U.S. Application Data
(60) Provisional application No. 61/913,102, filed on Dec. 6, 2013.

(30) Foreign Application Priority Data
Dec. 6, 2013 (CA) 2836757

(51) Int. Cl. A01N 43/90; A01N 27/00

(52) U.S. Cl. CPC A01N 43/90; A01N 27/00

(57) ABSTRACT

This disclosure features methods for the use of combinations including a paraffinic oil and a pigment for increasing resistance of plants to one or more abiotic stresses.

### TECHNICAL FIELD

This disclosure relates to methods of increasing resistance of plants to abiotic stresses using a combination that includes paraffinic oil and a pigment.

### BACKGROUND

Growing plants are subject to a variety of environmental stresses of a non-biological origin, referred to herein as abiotic stresses. Examples of abiotic stresses include cold stress, heat stress, drought stress, excess water stress, nutrient deficiency stress, lack of sunlight (i.e., shade) stress and stress caused by excess salt exposure. When plants are exposed to abiotic stresses, growth can be slowed as the plant diverts energy to biological defense mechanisms in an attempt to cope with the stress condition. One or all of these stresses can have a debilitating effect on plant health, quality and/or development and, may compromise crop yields and/or quality. The effects of abiotic stressors are especially important as it relates to climate change, as plants and growers must adapt quickly to cope with unexpected new or magnified abiotic stress conditions.

### SUMMARY

In a first aspect, there is provided a method for increasing resistance of a plant to one or more abiotic stresses, which method comprises applying an agriculturally effective amount of a combination to the plant, the combination comprising:
a paraffinic oil;
an emulsifier;
a pigment; and
water;

wherein the abiotic stress is cold stress, heat stress, water stress, transplant shock stress, low light stress or salinity stress.

In some implementations, the combination is applied to the plant at or before onset of the abiotic stress. The combination can be additionally applied to the plant after onset of the abiotic stress.

In some implementations, the combination is applied to the plant by soil drenching, foliar application, or a combination of soil drenching and foliar application.

In any implementation, the combination can further include a silicone surfactant.

In accordance with a second aspect, there is provided a method for increasing resistance of a plant to damage caused by cold stress, which comprises applying an agriculturally effective amount of a combination to the plant, the combination comprising:
a paraffinic oil;
an emulsifier;
a pigment; and
water.

The combination can further include a silicone surfactant.

In some implementations, the plant to which the combination is applied is a plant that is hardy in a first hardiness zone at temperatures between a first minimum temperature and a first maximum temperature; and the method further comprises the step of increasing resistance of the plant to cold stress comprises increasing hardiness of the plant to temperatures below the first minimum temperature. In embodiments in which the plant is a tree, the step of increasing resistance of the plant to damage comprises increasing cold hardiness of the plant by about 2 to about 4 degrees Celsius. In various embodiments, the tree can be a fruit-bearing tree such as an apple or peach tree.

In some implementations, the combination can be applied to the plant before onset of the cold stress and/or at the onset of cold stress and/or during cold stress.

In some implementations, the cold stress is a late frost that occurs after budding of the plant, and the combination has been applied prior to budding of the plant.

In some implementations, the increased resistance of the plant to cold stress comprises a delayed onset of dormancy of the plant.

In some implementations, the cold stress is an early frost that occurs before dormancy of the plant, and the combination has been applied prior to onset of the early frost.

In some implementations, the cold stress occurs during a winter season during dormancy of the plant, and the combination has been applied prior to dormancy of the plant.

In accordance with a third aspect, there is provided a method for increasing resistance of a plant to damage caused by drought stress, which comprises applying an agriculturally effective amount of a combination to the plant, the combination comprising:
a paraffinic oil;
an emulsifier;
a pigment; and
water;

wherein the plant is not a turfgrass.

The combination can further comprise a silicone surfactant.

In some implementations, the combination can be applied to the plant before onset of the drought stress and/or during the drought stress.

In some implementations, the combination is applied to the plant 1 to about 10 times prior to onset of the drought stress.

In some implementations, the plant comprises a wheat plant, and increasing resistance of the plant to drought stress comprises increasing protein yield in the wheat plant after being subjected to the drought stress as compared to before the drought stress.

In some implementations, the combination can be applied by soil drenching and/or foliar application prior to and/or at a flag leaf stage and/or at a flowering stage.

In accordance with a fourth aspect, a method is provided for increasing resistance of a plant to damage caused by heat stress, in which the method comprises applying an agriculturally effective amount of a combination to the plant, the combination comprising:
a paraffinic oil;
an emulsifier;
a pigment; and
water.

The combination can further include a silicone surfactant.

In some implementations, the plant is a plant that is hardy in a first hardiness zone at temperatures between a first minimum temperature and a first maximum temperature; and increasing resistance of the plant to damage comprises increasing hardiness of the plant to temperatures above the first maximum temperature.

In some implementations, the combination can be applied to the plant before onset of the heat stress and/or during the heat stress. In an embodiment, the combination is applied 1 to about 10 times prior to the onset of heat stress.

In some implementations, the plant is a turfgrass plant and increasing resistance of the plant comprises reducing degradation in quality of the turfgrass caused by the heat stress as compared to untreated turfgrass subjected to the heat stress.

In some implementations, the degradation in quality is a degradation in colour of the turfgrass and/or degradation of shoot density in turfgrass.

In accordance with a fifth aspect, a method is provided for increasing resistance of a plant to damage caused by salinity stress, which comprises applying an agriculturally effective amount of a combination to the plant, the combination comprising:
a paraffinic oil;
an emulsifier;
a pigment; and
water.

In some implementations, the combination further includes a silicone surfactant.

In some implementations, the combination can be applied to the plant before onset of the salinity stress and/or at the onset of salinity stress and/or during salinity stress.

In some implementations, the combination is applied to the plant 1 to about 10 times before onset of the salinity stress.

In some implementations, the plant is a turfgrass plant, and increasing resistance of the plant comprises reducing degradation in quality of the turfgrass caused by the salinity stress as compared to untreated turfgrass subjected to the salinity stress.

In some implementations, the plant comprises a wheat plant.

In some implementations, increasing resistance of the plant to damage caused by salinity stress includes obtaining higher dry weight and/or fresh weight values as compared to untreated plant subjected to the salinity stress.

In accordance with a sixth aspect, a method is provided for increasing resistance of a plant to damage caused by low light stress, which comprises applying an agriculturally effective amount of a combination to the plant, the combination comprising:
a paraffinic oil;
an emulsifier;
a pigment; and
water.

The combination can further include a silicone surfactant.

In some implementations, the low light stress is a periodic problem, and the combination is applied to the plant before onset of a period of low light stress and/or at the onset of low light stress and/or during low light stress.

In some implementations, the combination is applied to the plant 1 to about 10 times before onset of the period of low light stress.

In some implementations, the plant is a turfgrass plant, and increasing resistance of the plant comprises reducing degradation in quality of the turfgrass caused by the low light stress as compared to untreated turfgrass subjected to the low light stress.

In a further aspect, a method is provided for decreasing a dormancy period of a plant, which comprises applying an agriculturally effective amount of a combination to the plant, the combination comprising:
a paraffinic oil;
an emulsifier;
a pigment; and
water.

The combination can further include a silicone surfactant.

In some implementations, the combination is applied to the plant prior to the onset of dormancy and/or during dormancy.

In another aspect, a method is provided for increasing resistance of a plant to damage caused by one or more abiotic stresses, which comprises applying an agriculturally effective amount of a combination to the plant, the combination comprising:
a paraffinic oil;
an emulsifier;
a pigment; and
water;

wherein the plant is not a turfgrass.

The combination can further include a silicone surfactant.

In another aspect, a method is provided for increasing resistance of a plant to one or more abiotic stresses, which comprises applying an agriculturally effective amount of a combination to the plant, the combination comprising:
a paraffinic oil;
an emulsifier;
a pigment;
a silicone surfactant; and
water;

wherein the plant is not a turfgrass.

In another aspect, a method is provided for increasing resistance of a plant to one or more abiotic stresses, which comprises applying an agriculturally effective amount of a combination to the plant, the combination comprising:
a paraffinic oil;
an emulsifier;
a pigment;
a silicone surfactant; and
water;

wherein an abiotic stress is a stress chosen from: cold stress, heat stress, water stress, transplant shock stress, low light stress and salinity stress.

In another aspect, a method is provided for increasing resistance of a plant to damage caused by transplant shock stress, which comprises applying an agriculturally effective amount of a combination to the roots of the plant, the combination comprising:
a paraffinic oil;
an emulsifier;
a pigment; and
water.

The combination can further include a silicone surfactant.

In some implementations, the combination is applied at prior to and/or during and/or following the transplant.

In some implementations, the plant is a tomato plant, and increasing resistance of the plant comprises preventing or reducing stunting of growth of the plant caused by the transplant shock stress as compared to an untreated tomato plant subjected to the transplant shock stress.

In another aspect, a method is provided for increasing resistance of a plant to damage caused by water stress, which comprises applying an agriculturally effective amount of a combination to the plant, the combination comprising:
a paraffinic oil;
an emulsifier;
a pigment; and
water.

The combination can further include a silicone surfactant.

In some implementations, the combination is applied to the plant before onset of the water stress and/or at the onset of the water stress and/or during the water stress.

In some implementations, the combination is applied to the plant 1 to about 10 times before onset of the water stress.

In some implementations, the plant is a turfgrass plant, and increasing resistance of the plant comprises reducing degradation in quality of the turfgrass caused by the water stress as compared to untreated turfgrass subjected to the water stress.

In some implementations of the aspects outlined herein, the plant can be a non-woody crop plant, a turfgrass or a woody plant. In an embodiment, the woody plant is a tree. In further embodiments, the tree is a maple tree, a citrus tree, an apple tree, a pear tree, a peach tree, a cherry tree, an oak tree, an ash tree, a pine tree, a spruce tree, a shrub or any combination thereof.

In some of the implementations of the aspects outlined herein, the plant is not a turfgrass.

In some implementations of the aspects noted herein, the combination can be applied by soil drenching and/or foliar application and/or root bathing.

In some implementations of any of the aspects noted herein, the combination is applied diluted in water at a rate of about 0.1 to about 75 oz/1000 square feet.

In some implementations of any of the aspects noted herein, the paraffinic oil comprises a paraffin having from 16 carbon atoms to 35 carbon atoms.

In some implementations of any of the aspects noted herein, the paraffinic oil has a paraffin content of at least about 80%.

In some implementations of any of the aspects noted herein, the paraffinic oil comprises synthetic isoparaffins.

In some implementations of any of the aspects noted herein, the composition comprises a paraffinic oil-in-water emulsion.

In some implementations of any of the aspects noted herein, the weight ratio of the paraffinic oil to the emulsifier is from about 5:1 to about 500:1.

In some implementations of any of the aspects noted herein, the weight ratio of the paraffinic oil to the emulsifier is about 50:1.

In some implementations of any of the aspects noted herein, the composition can comprise and emulsifier, which can be a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or a composition thereof.

In some implementations of any of the aspects noted herein, the pigment is a copper phthalocyanine.

In some implementations of any of the aspects noted herein, the weight ratio of the paraffinic oil to the pigment is from about 1:5 to about 100:1.

In some implementations of any of the aspects noted herein, the weight ratio of the paraffinic oil to the pigment is about 30:1.

In some implementations of any of the aspects noted herein, the pigment is a water-based pigment dispersion.

In some implementations of any of the aspects noted herein, the pigment is an oil-based pigment dispersion.

In some implementations of any of the aspects noted herein, the combination further includes a silicone surfactant, and the silicone surfactant is a silicone polyether.

In some implementations of any of the aspects noted herein, the combination further includes a silicone surfactant, and the silicone surfactant comprises a polyethylene glycol according to formula IV:

R¹—O—(CH₂CH₂O)_{f}—R²

wherein R1=H or CH2=CH—CH2 or COCH3; R2=H or CH2=CH—CH2 or COCH3; and f≧1.

In some implementations of any of the aspects noted herein, the combination further includes a silicone surfactant, and wherein the weight ratio of the pigment to the silicone surfactant is from about 2:1 to about 50:1.

In some implementations of any of the aspects noted herein, the composition further comprises an anti-settling agent.

In some implementations of any of the aspects noted herein, the composition further comprises a plant growth regulator.

In some implementations of any of the aspects noted herein, the composition further comprises a QoI or DMI fungicide.

The details of one or more implementations of the combination and methods described herein are set forth in the accompanying description below. Other features and advantages of the combination and methods described herein will be apparent from the description and drawings, and from the claims.

### DESCRIPTION OF DRAWINGS

FIG. 1 is an image of apple trees (Left) and peach trees (right) prior to application of a combination.

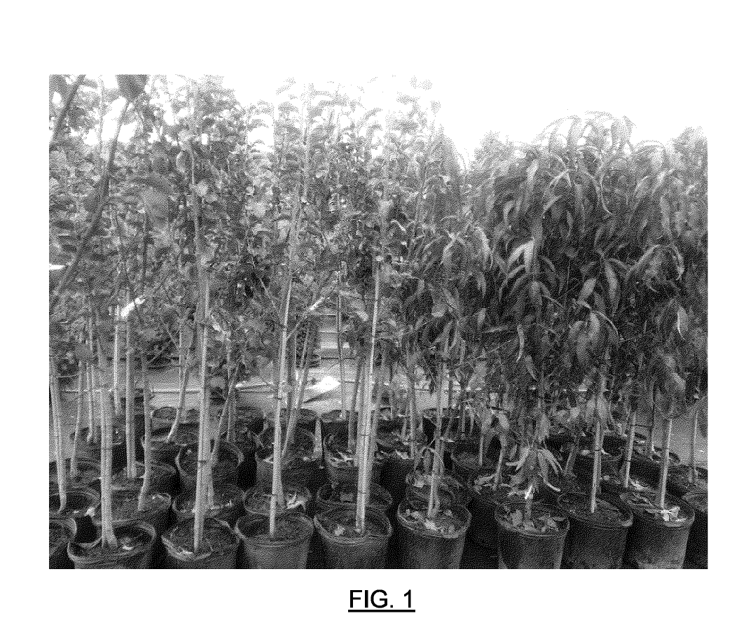

FIG. 2 is a cold hardiness analysis and estimation of LT₅₀ from controlled freeze testing data. Cold hardiness of apple trees treated with isoparaffin sampled on November 28. Damage code: 0=dead, 1=live.

FIG. 3A is a graph showing the mean plant height for spring wheat under salt stress, treated with treatments 1 to 5, as described in Example 8.

FIG. 3B is a graph showing the mean above ground plant biomass (fresh weight, g/plants) for spring wheat under salt stress, treated with treatments 1 to 5, as described in Example 8.

FIG. 3C is a graph showing the mean above ground plant biomass (dry weight, g/3 plants) for spring whean under salt stress, treated with treatments 1 to 5, as described in Example 8.

### DETAILED DESCRIPTION

It has been found that the combinations described herein are surprisingly effective in increasing the resistance of plants to damage caused by one or more abiotic stresses. Increased resistance can be exemplified by the reduction in degradation of quality of the plant, as compared to an untreated plant subjected to the same stress. For example, a plant subjected to an early frost in the fall prior to dormancy of the plant can be protected from damage to the plant by application of the combination before, during or after onset of the early frost, i.e., the cold stress. In some implementations, increased resistance to abiotic stress can be exemplified by maintained or improved plant quality, as compared to an untreated plant subjected to the same stress.

In the methods described below, a combination is used to increase the resistance of a plant to an abiotic stress. The combination includes a paraffinic oil and a pigment. The combination can also include an emulsifier, a silicone surfactant and water. The combination can be an oil-in-water emulsion, where the emulsifier and the surfactant are selected such that the pigment is maintained in dispersion in the oil-in-water emulsion for delivery to the plant. In the description below, references to a combination mean a combination of at least paraffinic oil and a pigment.

Generally, a specific plant species will thrive in environmental conditions that are similar to the climate of its native geographic location. That is, plants that are native to tropical climates at sea level may not thrive in cool or dry climates, or at high elevations where soil depth is minimal and conditions are windy. Accordingly, when a grower, landscaper, farmer, or homeowner is selecting plants and trees to grow on their land, they typically select plants that are either native to the surrounding geographic area, or are native to a geographic area with comparable climate and growing conditions.

To aid growers in this selection, many tools have been developed to map climatic zones (typically based on seasonal high and low temperatures) and to correlate these zones to plants and trees that are most likely to thrive in those zones. For example, in the United States Department of Agriculture (USDA) system, a plant that is “hardy to zone 10” means that the plant can withstand a minimum temperature of −1° C., while a more resilient plant that is “hardy to zone 9”, can withstand a minimum temperature of −7° C. While the USDA system is based on minimum survival temperature, other environmental conditions such as water and nutrient availability, shade, and wind may also limit a plant's ability to thrive. Some plants can thrive in a broader range of growing conditions, while other plant species are limited to a narrow range of growing conditions. The latter are said to be less hardy than the former, but it is possible for hardiness to vary by environmental condition. That is, certain plants may be more drought hardy (drought tolerant), while other plants may be more wind hardy.

As used herein, the hardiness of a tree, crop, or plant refers to its ability to survive adverse environmental (abiotic) conditions, such as cold, heat, drought, flooding, shade, soil nutrient deficiency, and wind. Natural resistance to a given adverse abiotic condition will vary by genus, species, and cultivar. For example, a certain type of fruit tree may not survive a winter in which temperatures drop to 5° C. Therefore, a grower in a climate in which winter temperatures average 10° C. may be hesitant to plant the first type of fruit tree for fear that an unusually cold winter may significantly reduce his crop and potentially destroy his orchard. Likewise, a residential vegetable farmer may plan his garden plot based on the amount of shade coverage and sun exposure, planting heat hardy plants in the sunny location and shade hardy plants in the shaded areas.

As climatic conditions may change over time, a grower may wish to increase the hardiness of a plant, tree, or crop to minimize risk of economic loss based on predicted or unexpected abiotic stresses. Further, growers may wish to attempt to grow crops that are not expected to thrive in their geographic zone and expected soil conditions. In these circumstances, growers must carefully monitor environmental conditions and mitigate risk that these conditions will result in loss of the plant. For example, growers in cold climates may cover plants or shrubs for the winter, may supplement poor soil quality with fertilizer or other chemicals, or may construct wind screens. Methods to generally improve a plant's resistance to abiotic stressors would allow growers to avoid or limit such steps, and would enable growers to extend the natural limit of environmental conditions beyond those common to its native geographic location.

Application of the combination to a plant, e.g., a shrub, tree, vine, or crop (generally referred to herein as a plant) can improve the hardiness of the plant and can allow the plant to withstand growing conditions that are outside the range of native growing conditions for that plant. Such conditions are considered to be abiotic stressors. Examples of specific abiotic stress conditions are described below.

Cold Hardiness

When the abiotic stress is cold stress, application of the combination can improve cold hardiness of the plant. That is, application of the combination can allow the plant to withstand temperature conditions that are colder than would typically be experienced in the plant's optimal or native growing conditions. Various types of cold stress are possible, such as unexpected frost (for example an early fall frost when healthy crop, fruit, or leaves are still present on the plant, or a late spring frost that occurs after spring growth has begun), a cooler than native growing season, colder than native winter conditions, minimal winter snow cover, ice accumulation, etc.

It should be noted that what constitutes a cold stress condition for one plant may not be a cold stress condition for another plant. With reference to the USDA zone map, a cold stress condition for a zone 9 plant may in fact be a native growing condition for a zone 8 plant. Likewise, the depth of snow cover required for survival of a rosebush may not be required for a rhubarb plant.

Various types of cold stress are possible, depending on the type of plant in question.

The Examples illustrate that combined use of paraffinic oil with a pigment can allow the plant (e.g., a tree) to better withstand low temperatures. Since cold weather damage may impact fruit-bearing ability in subsequent growing seasons, it is desired to reduce cold weather damage to a fruit-bearing plant (e.g. Fruit tree or vines).

The combination may be used to protect plants, including woody and non-woody, from frost injury. The frost can be an early frost, for example after harvest and before dormancy or late frost for example, after budding. The cold damage can also be winterkill induced by winter temperatures, which may result in a loss of viable branches or shoots. Plants treated by the combination can be frost or cold sensitive plants, in that they are naturally susceptible to frost, freezing or cold damage or injury in economically or aesthetically significant amounts.

In some implementations, increasing resistance to cold stress is exemplified by a delayed onset of dormancy. Plant dormancy can be triggered by a drop in temperature, e.g., the onset of cold stress. By increasing resistance of the plant to cold stress, dormancy of the plant can be delayed until triggered by a further drop in temperature.

The Examples illustrate that use of the combination periodically (e.g., at 2-3 week intervals starting with spring greenup) and/or by applying one or more treatments (e.g., 2 in the fall), can provide an unexpected response in reducing or delaying the dormancy period of the tested plants (e.g., turfgrass). In another aspect, methods and uses are provided for combinations that include a paraffinic oil-in-water emulsion for reducing the dormancy period of a plant or extending the growing period of the plant or to promote early spring green-up of turfgrass.

As used herein, the term “reducing dormancy period” (and the like) refers to a plant that has a reduced dormancy period or extended growing period relative to a control, e.g., a non-treated plant.

Plants can be treated individually, or as crops of like plants, such as row crops planted in an agricultural field. Typically, the plants, or fruit from the plants, are harvested at some point following treatment, although the methods as described herein can be carried out on plants that are not harvested (e.g. turfgrass, ornamental plants, flowers, etc.).

In some implementations, the harvesting step can be carried out one week, one month, two months or more after the last application of the combination, with the active agent still being effective to reduce the effects of cold stress on the plant during the intervening period.

In one aspect, resistance to cold stress includes resistance to early or late frost, winter damage/kill.

In one aspect, the combination can be used to protect early growth from cold during fluctuations in temperature (e.g., in early spring).

In one aspect, the combination can be used to protect plants (e.g., a fruit tree) from cold during the cold months (e.g., in winter).

In one aspect, the combination can be applied by soil drenching and/or foliar application (e.g., sprayed until run-off) at the onset or prior to exposure to the low temperature (e.g., late fall when the trees are in full leaf, healthy and vigourous. In one aspect, the combination can be applied by soil drenching and/or foliar application (e.g., sprayed until run-off) during late fall and winter.

In one aspect, the combination can be applied by soil drenching in the late fall following by a foliar application (e.g., sprayed until run-off) in the winter in order to reach maximum hardness.

In one aspect, the combination can be applied 1-4 times (i.e., 2-4) at a 1-6 month interval (e.g., 2-3 month).

Further treatments can be applied in the spring and/or during the growing season to improve resistance to subsequent cold stress conditions.

In one aspect the plant is a fruit tree (e.g. cherry, pear, peach, apple, etc.).

In one aspect, the combination can be applied in November, January, February and March for apple trees and November and January for peach trees.

Heat Hardiness

When the abiotic stress is heat stress, application of the combination can improve tolerance to high temperatures during the growing season. That is, application of the combination can allow the plant to withstand temperature conditions that are higher than would typically be experienced in the plant's optimal or native growing conditions. Heat stress can have various causes, such as lack of shade for plants that typically require shaded growing conditions, or higher than normal summer temperatures.

It should be noted that what constitutes a heat stress condition for one plant may not be a heat stress condition for another plant. With reference to the USDA zone map, a cold stress condition for a zone 6 plant can in fact be a native growing condition for a zone 8 plant.

The Examples illustrate combined use of paraffinic oil with a pigment, wherein the combination is periodically applied to a plant (e.g., weekly for a period of 3 weeks) prior to or at the onset of the heat stress, and provides an unexpected response in preventing or reducing plant quality degradation caused by excess heat.

Shade Hardiness

Shade stress, or “low light (LL) stress” can be a problem that influences plant growth and quality. When the abiotic stress is shade stress, application of the combination can improve shade hardiness of the plant. That is, application of the combination can allow the plant to withstand shady conditions for plants whose optimal or native growing conditions typically require partial or full sun exposure. Various types of shade stress are possible, such as a prolonged period of cloudy weather, excessive growth of adjacent plants or trees that cast shade onto the plant, or lack of availability of a sunny planting location.

Shade can be a periodic problem. For example, during certain months of the year, a structure situated near a plant may cast a shadow on the plant, causing a shade stress. As the earth moves over the course of a year, the structure may no longer cast the shadow on the plant for another series of months and then the situation can be repeated during the next annual cycle. In such instances, the combination can be applied to the plant prior to onset of the period of shade stress and can also be applied during the period of shade stress. The damage to the plant that would typically result on account of the period of shade stress can be prevented or reduced. Shade conditions are not considered to be an abiotic stress condition for many types of plants, as some plants have a requirement for shade as part of their optimal growing conditions.

The Examples illustrate that the combined use of paraffinic oil with a pigment applied periodically (e.g., at 1-4 week (e.g., 14 days) interval by foliar application) under low light conditions can increase the tolerance of turfgrass to unfavorable light conditions.

Drought Hardiness

Drought can be defined as the absence of rainfall or irrigation for a period of time sufficient to deplete soil moisture and injure plants. Drought stress results when water loss from the plant exceeds the ability of the plant's roots to absorb water and/or when the plant's water content is reduced enough to interfere with normal plant processes.

The severity of the effect of a drought condition can vary between plants, as the plant's need for water can vary by plant type, plant age, root depth, soil quality, etc.

The combination can be applied to a plant prior to onset of a drought and/or during a drought. Application of the combination can increase the resistance of the plant to the drought stress. Increasing resistance can include maintaining or increasing a quality of the plant as compared to an untreated plant subjected to the same drought stress. Increasing resistance can include reducing the degradation in quality of the plant, as compared to an untreated plant subjected to the same drought stress.

The Examples illustrate that use of the combination applied during terminal drought of wheat (e.g., after flowering) can provide an unexpected response in preventing or reducing damage and loss of yield associated with drought stress, and in increasing protein content. The examples also show that the yield quality traits are improved (e.g., flour protein, and baking quality). If plants do not receive adequate rainfall or irrigation, the resulting drought stress can reduce growth more than all other environmental stresses combined. The Examples illustrate that use of the combination during the terminal drought of wheat increases protein level without yield loss relative to the untreated wheat.

In one implementation, the combination is applied in at least two stages (e.g., at flag leaf and flowering stages).

Transplant Shock

A plant that is subjected to a transplant from one growing environment to another, e.g., from a pot to flower bed or garden, can be subjected to transplant shock stress as a result of exposure to new environmental conditions such as wind, direct sun, or new soil conditions. Application of the combination to the roots of the plant can reduce the impact to the plant caused by the transplant. In some implementations, stunting of plant growth and/or development of a transplanted plant can be reduced or prevented by application of the combination.

The Examples illustrate that treating a transplanted plant with the combination, for example, by soaking, pre-soaking and/or foliar application, for a determined time (e.g., 2-8 hours or until run-off) on the day of transplant, provides an unexpected response in reducing transplant shock in the tested plants (e.g., tomatoes) by reducing stunted plants relative to a control.

In one implementation, the combination is applied by tray soak and/or foliar application.

Excess Water—Flooding

Although plants require a certain volume of water for healthy plant growth and development, the exposure of a plant to excess volumes of water (“water stress”) can damage the plant. Application of the combination to a plant prior to the onset of an excess water condition can increase the plant's resistance to the water stress. The combination can be applied during the water stress, however, dilution of the combination may occur on account of the excess water. Accordingly, pre-treatment in advance of a period of excess water can be more effective.

The Examples illustrate that use of the combination periodically (e.g., at 2-3 week intervals starting with spring greenup) can increase the tolerance of turfgrass to unfavorable moisture conditions and nutrient deficiency. The Examples illustrate that the treatment with the combination provides an unexpected response in preventing or reducing damage associated with excess water and nutrient stress by improving, in most cases, shoot density, color and overall quality (especially when the dormancy period normally starts).

Prevention of Salt Damage

Salts can be naturally present in the growing environment of a plant. Salinity stress, refers to osmotic forces exerted on a plant when the plant is growing in a salt marsh or under other excessively saline conditions. For example, plants growing near a body of salt water can be exposed to salt present in the air or in water used to water the plants. In another example, salt applied to road, sidewalk and driveway surfaces during the winter for improved driving conditions can be transferred and/or leach into the soil of plants growing in the proximity. Such increased salt content in a growing environment of the plant can result in salinity stress, which can damage the plant. Application of the combination to the plant can increase the plant's resistance to the salinity stress, and prevent or reduce a deterioration in quality of the plant which would occur if untreated. The combination can be applied prior to or during the period of salinity stress.

The Examples illustrate that the combined use of paraffinic oil with a pigment applied periodically (e.g., at 1-2 time weekly followed by repeat applications every 14 days by foliar application) under excess salt conditions can increase the tolerance of turfgrass to the presence of the excess salt.

Combinations

In one aspect, combinations are featured that include various combinations of a paraffinic oil-in-water emulsion with a pigment. In some implementations, the combination includes a paraffinic oil, a pigment, an emulsifier, a silicone surfactant and water.

The combination can further include (but are not limited to) one or more of the following: one or more anti-settling agents, one or more plant growth regulators, one or more conventional chemical fungicides (e.g., a DMI or a QoI), and/or water. In some implementations, the combination can be in the form of a single composition (e.g., which is contained within a storage pack or a vessel (e.g., a tank) suitable for applying the composition to a plant, e.g., crop plant). Typically, the composition is applied to a plant after dilution with water. In other implementations, the combination can include two or more separately contained (e.g., packaged) compositions, each containing one or more of the above-mentioned components. Said compositions can be combined and applied to a plant typically after dilution with water; or each composition can be applied separately to the same plant either simultaneously or sequentially, and typically after dilution with water. This disclosure also features methods of using the combination for increasing stress resistance or reducing the dormancy period of a plant as well as methods of formulating the combination that include both oil and water as oil-in-water (O/W) emulsions.

The paraffinic oil-in-water emulsion includes paraffinic oil and an emulsifier and can further include any one or more of the components listed above.

The paraffinic oil can include a paraffin having a number of carbon atoms of from 12 to 50. The paraffin can have a number of carbon atoms of from about 16 to 35. The paraffin can have an average number of carbon atoms of 23.

The paraffinic oil can have a paraffin content of at least 80%. The paraffinic oil can have a paraffin content of at least 90%. The paraffinic oil can have a paraffin content of at least 99%.

The paraffinic oil can be used in a range from about 5 to 3200 oz./acre (i.e. 0.1 to 75 oz./1000 square feet). The paraffinic oil can be used in a range from about 40 to about 640 oz/acre. The oil-in-water emulsion can be used in a range from about 2 to 200 gallons per acre for foliar application. The oil-in-water emulsion can be used in a range from about 200 to 800 gallons per acre for soil drench application or water-in application with irrigation.

In some implementations, the combinations can further include a plant growth regulator. Growth regulators include fertilizers and plant hormones (e.g., auxins including IBA and IAA, ethylene, ethylene inhibitors, ethylene releasers, gametocides, gibberellins, cytokines, polyamines, antiauxins, growth inhibitors such as abscisic acid, growth retardant such as Gibberellin Biosynthesis Inhibitor including paclobutrazol, flurprimidol and trinexapac-ethyl, growth stimulators such as brassinolide etc.)

In some implementations, the combinations can further include a de-methylation inhibitor (DMI). The DMI can be tetraconazole, tebuconazole, propioconazole, azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, prothioconazole, simeconazole, triadimefon, triadimenol, triticonazole, imazalil, oxpoconazole, pefurazoate, prochloraz, triflumizole, fenarimol, nuarimol, triforine, or pyrifenox. The DMI can be tebuconazole, and can be used in a range from about 0.02 to about 0.5 lb. ai./acre. The DMI can be propioconazole, and can be used in a range from about 0.01 to about 0.6 lb. ai./acre. The DMI can be tetraconazole, and can be used in a range from about 0.015 to 0.15 lb. ai./acre. The DMI can be prothioconazole, and can be used in a range from about 0.02 to 0.4 lb. ai./acre.

In some implementations, the combinations can further include a Quinone outside Inhibitor (QoI). The QoI can be azoxystrobin, enestrobin, picoxystrobin, pyraclostrobin, trifloxystrobin, dimoxystrobin, metominostrobin, orysastrobin, famoxadonem, fluoxastrobin, fenamidone, or pyribencarb. The QoI can be azoxystrobin, and can be used in a range from about 0.01 to 0.50 lb. ai./acre. The QoI can be pyraclostrobin, and can be used in a range from about 0.02 to 0.40 lb. ai./acre.

In some implementations, the combinations can include an emulsifier. Examples of emulsifiers include (but are not limited to), a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or a combination thereof.

In some implementations, the pigment comprises a (Cu II) phthalocyanine, and in some implementations is a polychlorinated (Cu II) phthalocyanine. In some implementations the pigment is dispersed in water and in some implementations the pigment is dispersed in oil.

In some implementations, the combination can include a silicone surfactant.

In some implementations, the combination includes paraffinic oil, a pigment, a silicone surfactant, and an emulsifier.

In some implementations, the pigment can be dispersed in oil, and the emulsifier can include a natural or synthetic alcohol ethoxylate, a polymeric surfactant, a sorbitan fatty acid ester, or a combination thereof, and the combination further includes a polyethylene glycol according to formula IV:

R¹—O—(CH₂CH₂O)_{f}—R²
wherein R1=H or CH2=CH—CH2 or COCH3; R2=H or CH2=CH—CH2 or COCH3; and f≧1.

In some implementations where the combination includes a paraffinic oil, pigment and silicon surfactant, the ratio of the paraffinic oil-in-water emulsion to the combination of the pigment and the silicone surfactant can be from about 32:1 to 4:1.

In some implementations, the ratio of the paraffinic oil to the pigment can be from about 5:1 to 100:1, such as 30:1.

In some implementations, where the combination includes a paraffinic oil, pigment and an emulsifier, the weight ratio of the paraffinic oil to the emulsifier can be from about 5:1 to 500:1.

In some implementations, the weight ratio of the pigment to the silicone surfactant can be from about 2:1 to 50:1.

In some implementations, where the combination includes a conventional chemical fungicide, the weight ratio of the paraffinic oil to the conventional chemical fungicide can be from about 2:1 to 10,000:1

In some implementations, the combination can further include one or more anti-settling agents.

In some implementations, the combination can further include one or more growth regulators.

As used herein, the term “oil-in-water emulsion” refers to a mixture in which one of the paraffinic oil and water (e.g., the paraffinic oil) is dispersed as droplets in the other (e.g., the water). In some implementations, an oil-in-water emulsion is prepared by a process that includes combining the paraffinic oil, water, and any other components and the paraffinic oil and applying shear until the emulsion is obtained (typically a white milky color is indicative of the formation of an emulsion in the absence of any pigment; a green color is observed in the presence of a pigment). In other implementations, an oil-in-water emulsion is prepared by a process that includes combining the paraffinic oil, water, and any other components in the mixing tank and spraying through the nozzle of a spray gun.

As used herein, the term “increasing stress resistance” (and the like) refers to an increase in the ability of a plant to survive or thrive in stress conditions. Enhanced resistance can be specific for a particular stressor, e.g., drought, excess water, nutrient deficiency, salt, cold, shade or heat, or can be increased resistance for multiple stressors. Typically, enhanced resistance is determined relative to a control, e.g., a non-treated plant.

The term “agriculturally effective amount” and the like refer to that amount of active ingredients agent that will elicit the desired response of a plant.

As used herein, the plant can be a woody plant, or non-woody crop plant or turf grass

As used herein, the term a non-woody crop plant refers to crop plant which is grown, tended to, and harvested in a cycle of one year or less as source of foodstuffs and/or energy. Examples of crop plants include, without limitation, sugar cane, wheat, rice, corn (maize), potatoes, sugar beets, barley, sweet potatoes, cassava, soybeans, tomatoes, legumes (beans and peas), carrots, onion, and other vegetables.

As used herein, the term woody plant refers to “tree”, shrub and vine, which refers to a woody perennial plant having a single stem or trunk and bearing lateral branches at some distance from the ground. In certain implementations, the tree is deciduous such as fruit trees. In other implementations, the tree is evergreen (e.g., coniferous). In still other implementations, the tree is deciduous or evergreen and is grown, tended to, and harvested in a cycle of one year or less as source of foodstuffs. In a further implementation, the plant is a shrub. Examples of trees include, without limitation, maple trees, citrus trees, apple trees, pear trees, peach trees, an oak tree, an ash tree, a pine tree, and a spruce tree. In some implementations, the woody plant is a vine. Examples of vines include grape vines.

In some implementations, the plant is a turf grass. As used herein, the term “turf grass” refers to a cultivated grass that provides groundcover, for example a turf or lawn that is periodically cut or mowed to maintain a consistent height. Grasses belong to the Poaceae family, which is subdivided into six subfamilies, three of which include common turf grasses: the Festucoideae subfamily of cool-season turf grasses; and the Panicoideae and Eragrostoideae subfamiles of warm-season turf grasses. A limited number of species are in widespread use as turf grasses, generally meeting the criteria of forming uniform soil coverage and tolerating mowing and traffic. In general, turf grasses have a compressed crown that facilitates mowing without cutting off the growing point. In the present context, the term “turf grass” includes areas in which one or more grass species are cultivated to form relatively uniform soil coverage, including blends that are a combination of differing cultivars of the same species, or mixtures that are a combination of differing species and/or cultivars.

Examples of turf grasses include, without limitation:
bluegrasses (Poa spp.), such as Kentucky bluegrass (Poa pratensis), rough bluegrass (Poa trivialis), Canada bluegrass (Poa compressa), annual bluegrass (Poa annua), upland bluegrass (Poa glaucantha), wood bluegrass (Poa nemoralis), bulbous bluegrass (Poa bulbosa), Big Bluegrass (Poa ampla), Canby Bluegrass (Poa canbyi), Pine Bluegrass (Poa scabrella), Rough Bluegrass (Poa trivialis), Sandberg Bluegrass (Poa secunda);
the bentgrasses and Redtop (Agrostis spp.), such as creeping bentgrass (Agrostis palustris), colonial bentgrass (Agrostis capillaris), velvet bentgrass (Agrostis canina), South German Mixed Bentgrass (Agrostis spp. including Agrostis tenius, Agrostis canina, and Agrostis palustris), Redtop (Agrostis alba), Spike Bentgrass (Agrostis exerata);
the fescues (Festucu spp.), such as red fescue (Festuca rubra spp. rubra) creeping fescue (Festuca rubra), chewings fescue (Festuca rubra commutata), sheep fescue (Festuca ovina var. ovina), hard fescue (Festuca longifolia), hair fescue (Festucu capillata), tall fescue (Festuca arundinacea), meadow fescue (Festuca elatior), Arizona Fescue (Festuca arizonica), Foxtail Fescue (Festuca megalura), Idaho Fescue (Festuca idahoensis), Molate Fescue (Festuca rubra);
the ryegrasses (Lolium spp.), such as annual ryegrass (Lolium multiflorum), perennial ryegrass (Lolium perenne), and italian ryegrass (Lolium multiflorum);
the wheatgrasses (Agropyron spp.), such as crested wheatgrass (Agropyron cristatum), desert wheatgrass (Agropyron desertorum), western wheatgrass (Agropyron smithii), Intermediate Wheatgrass (Agropyron intermedium), Pubescent Wheatgrass (Agropyron trichophorum), Slender Wheatgrass (Agropyron trachycaulum), Streambank Wheatgrass (Agropyron riparium), Tall Wheatgrass (Agropyron elongatum), and Bluebunch Wheatgrass (Agropyron spicatum);
beachgrass (Ammophila breviligulata);
Brome grasses (Bromus spp.), such as Arizona Brome (Bromus arizonicus), California Brome (Bromus carinatus), Meadow Brome (Bromus biebersteinii), Mountain Brome (Bromus marginatus), Red Brome (Bromus rubens), and smooth bromegrass (Bromus inermis);
cattails such as Timothy (Phleum pratense), and sand cattail (Phleum subulatum); orchardgrass (Dactylis glomerata);
Alkaligrass (Puccinellia distans);
crested dog's-tail (Cynosurus cristatus);
Bermudagrass (Cynodon spp. such as Cynodon dactylon); hybrid bermudagrass such as tifdwarf bermudagrass, ultradwarf bermudagrass, tifgreen bermudagrass, tifsport bermudagrass, GN-1 bermudagrass, Ormond bermudagrass, and tifway bermudagrass;
Zoysiagrasses (Zoysia spp.) such as Zoysia japonica, Zoysia matrella, and Zoysia tenuifolia;
St. Augustinegrass (Stenotaphrum secundatum) such as Bitter Blue St. Augustinegrass, Seville St. Augustinegrass, Floratam St. Augustinegrass, Floralawn St. Augustinegrass, Floratine St. Augustinegrass, Raleigh St. Augustinegrass, and Texas Common St. Augustinegrass;
Centipedegrass (Eremochloa ophiuroides);
Carpetgrass (Axonopus fissifolius);
Bahiagrass (Paspalum notatum);
Kikuyugrass (Pennisetum clandestinum);
Buffalograss (Buchloe dactyloids);
Seashore paspalum (Paspalum vaginatum); Blue Grama (Bouteloua gracilis); Black Grama (Bouteloua eriopoda); Sideoats Grama (Bouteloua curtipendula);
Sporobolus spp., such as Alkali Sacaton (Sporobolus airiodes);
Sand Dropseed (Sporobolus cryptandrus), and Prairie Dropseed (Sporobolus heterolepis);
Hordeum spp., such as California Barley (Hordeum californicum),
Common Barley (Hordeum vulgare), and Meadow Barley (Hordeum brachyantherum);
Alopecurus spp., such as Creeping Foxtail (Alopecurus arundinaceaus), and Meadow Foxtail (Alopecurus pratensis);
Stipa spp., such as Needle & Thread (Stipa comata), Foothill Needlegrass (Stipa lepida), Green Needlegrass (Stipa viridula), Nodding Needlegrass (Stipa cernua), and Purple Needlegrass (Stipa pulchra);
Elymus spp., such as Blue Wildrye (Elymus glaucus), Canada Wildrye (Elymus Canadensis), Creeping Wildrye (Elymus triticoides), and Russian Wildrye (Elymus junceus);
Buffelgrass (Cenchrus ciliaris);
Big Quaking Grass (Briza maxima);
Big Bluestem (Andropogon gerardii),
Little Bluestem (Schizachyruim scoparium, and Sand Bluestem (Andropogon hallii);
Deergrass (Muhlenbergia rigens);
Eastern Gamagrass (Tripsacum dactyloides);
Galleta (Hilaria jamesii);
Tufted Hairgrass (Deschampsia caespitosa);
Indian Rice Grass (Oryzopsis hymenoides);
Indian Grass (Sorghastrum nutans);
Sand Lovegrass (Eragrostis trichodes); Weeping Lovegrass (Eragrostis curvula);
California Melic (Melica californica);
Prairie Junegrass (Koeleria pyramidata);
Prairie Sandreed (Calamovilfa longifolia);
Redtop (Agrostis alba);
Reed Canarygrass (Phalaris arundinacea);
Sloughgrass (Spartina pectinata);
Green Sprangletop (Leptochloa dubia);
Bottlebush Squirreltail (Sitanion hystrix);
Panicum Switchgrass (virgatum); and
Purple Threeawn (Aristida purpurea).

I. Components

The combination can include isomers such as geometrical isomers, optical isomers based on asymmetric carbon, stereoisomers and tautomers of the compounds described herein and are not limited by the description of the compounds for the sake of convenience.

[A] [This section intentionally left blank.]

[B] Paraffinic Oil

The paraffinic oil in combination with a pigment is confers properties that are useful for increasing stress resistance or reducing the dormancy period of a plant.

[1]

In some implementations, the paraffinic oil includes an oil enriched in paraffin.

In certain implementations, the paraffinic oil includes a paraffin having from 12 carbon atoms to 50 carbon atoms (e.g., 12 carbon atoms to 40 carbon atoms, 16 carbon atoms to 35 carbon atoms, 12 carbon atoms to 21 carbon atoms; e.g., 16 carbon atoms to 35 carbon atoms).

In certain implementations, the paraffinic oil includes a paraffin having an average number of carbon atoms that is less than or equal to about 20 (e.g., 16).

In certain implementations, the paraffinic oil includes a paraffin having an average number of carbon atoms of from 16 to 30 e.g., 23 or 27.

In certain implementations, the paraffinic oil includes a paraffin having from 16 carbon atoms to 35 carbon atoms and an average number of carbon atoms of 23.

In certain implementations, the paraffin is an isoparaffin (e.g., a synthetic isoparaffin manufactured from two-stage Severe Hydrocracking/Hydroisomerization process).

In some implementations, a paraffin is present in the paraffinic oil in an amount, that is at least about 80% (e.g., at least 90%, at least 99%).

[2]

In some implementations, the paraffinic oil has been refined to remove compounds that are associated with plant injury, for example, aromatic compounds or compounds containing sulfur, nitrogen, or oxygen. In certain implementations, the paraffinic oil includes relatively low levels of aromatic compounds and/or compounds containing sulfur, nitrogen, or oxygen, e.g., less than 10 weight percent (less than 5 weight percent, less than 2 weight percent, less than 0.5 weight percent) of aromatic compounds and/or compounds containing sulfur, nitrogen, or oxygen.

[3]

Non-limiting examples of suitable paraffinic oils include, HT60, HT100, High Flash Jet, LSRD, and N65DW (available from Petro-Canada, Calgary, AB, Canada).

[C] Emulsifier

In some implementations, the combination includes paraffinic oil, a pigment and an emulsifier, and water. It can be advantageous to store and/or apply such combinations as oil-in-water (O/W) emulsions.

Emulsions tend to be thermodynamically unstable due to excess free energy associated with the surface of the dispersed droplets such that the particles tend to flocculate (clumping together of dispersed droplets or particles) and subsequently coalesce (fusing together of agglomerates into a larger drop or droplets) to decrease the surface energy. If these droplets fuse, the emulsion will “break” (i.e., the phases will separate) destroying the emulsion, which in some cases can be detrimental to the storage shelf-life of the combinations. While not wishing to be bound by theory, it is believed that the addition of one (or more) emulsifying agents or emulsifiers can prevent or slow the “breaking” of an emulsion. As the skilled artisan will appreciate, the type and concentration of a particular emulsifying agent will depend, inter alia, on the emulsion phase components and the desired result.

[1]

In some implementations, the emulsifier is a “fast break” or “quick break” emulsifier. While not wishing to be bound by theory, it is believed that a “fast break” or “quick break” emulsifier allows the paraffinic oil to be quickly released from the O/W emulsion upon application to the turfgrass. When a “fast break” or “quick break” emulsifier is present in a suitable amount (for example a selected proportion or ratio with respect to the paraffinic oil), the resulting “fast break” or “quick break” O/W emulsion quickly releases the oil phase upon application to the turfgrass. As such, there is less runoff of the O/W emulsion from the grass blades (as compared to more stable O/W emulsions) resulting in more oil adhering to plant (e.g., turfgrass) for a longer period of time. In certain implementations, the oil phase resides on the plant (e.g., turfgrass) for a period of not less than one hour. In certain implementations, the oil phase resides on the plant (e.g., turfgrass) for a period of from not less than 1 hour but not more than 30 days. In certain implementations, the “fast break” or “quick break” emulsion can be, for example, an emulsion having an oil phase that, after mixing with water, is reconstituted in 0.5 to 15 minutes according to the following test:
1. Fill 100 mL graduated cylinder with tap water.
2. Add 1 mL of emulsified oil.
3. Invert graduated cylinder 5 times.
4. Using a stop watch and human observation, measure how long it takes for the oil phase to reconstitute after inversion (step 3).

In some implementations, the oil phase is reconstituted in from 2 minutes to 5 minutes according to the test described above. In some instances, the “fast break” or “quick break” property of the O/W emulsion is balanced with the need to provide an O/W emulsion with a suitable shelf life under suitable storing conditions, and for a suitable timeframe.

[2]

In some implementations, the emulsifier is (or includes) one (or more of the following) a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or any combination thereof.

In certain implementations, the emulsifier is (or includes) a natural or synthetic alcohol ethoxylate, a polymeric surfactant, a sorbitan fatty acid ester, or any combination thereof.

In certain implementations, the natural or synthetic alcohol ethoxylate is a polyoxyethylene (4 to 12) lauryl ether (C12), polyoxyethylene (10) cetyl ether (C16), polyoxyethylene (10) stearyl ether (C18), polyoxyethylene (10) oleyl ether (C18 mono-unsaturated), a polyoxyethylene (2 to 11) C12-C15 alcohol, a polyoxyethylene (3 to 9) C11-C14 alcohol, a polyoxyethylene (9) C12-C14 alcohol, a polyoxyethylene (11) C16-C18 alcohol, a polyoxyethylene (20) C12-C15 alcohol, or any combination thereof. For example, the natural or synthetic alcohol ethoxylate can be a polyoxyethylene (4 to 7) lauryl ether (C12), polyoxyethylene (10) cetyl ether (C16), a polyoxyethylene (2 to 11) C12-C15 alcohol, a polyoxyethylene (3 to 9) C11-C14 alcohol, a polyoxyethylene (9) C12-C14 alcohol, or any combination thereof. As another example, the alcohol alkoxylate can be a butyl ether polyoxyethylene/polyoxypropylene block copolymer.

In certain implementations, the emulsifier is (or includes) an alkyl polysaccharide, e.g., a C8-C11 alkylpolysaccharides or any combination thereof.

In certain implementations, the emulsifier is (or includes) a glycerol oleate, e.g., a glycerol mono-, di-, tri-oleate, or any combination thereof.

In certain implementations, the emulsifier is (or includes) a polyoxyethylene-polyoxypropylene block copolymer, e.g., a polyoxyethylene-polyoxypropylene block copolymer having a molecular weight (or relative molar mass) of from about 1100 to about 11400 and about 10 to 80% (ethylene oxide) EO.

In certain implementations, the emulsifier is (or includes) an alkyl phenol ethoxylate, e.g., a nonyl phenol ethoxylate, a dodecyl phenol ethoxylate, or any combination thereof. For example, the nonyl phenol ethoxylate can be a polyoxyethylene (2 to 8) nonylphenol.

In certain implementations, the emulsifier is (or includes) a polymeric surfactant, e.g., a graft copolymer, a random copolymer, or any combination thereof. For example, the graft copolymer can be a polymethacrylic acid and acrylate with polyoxyethylene chains. For example, the random copolymer can be a random copolymer having ester and ether groups.

In certain implementations, the emulsifier is (or includes) a polyethylene glycol, e.g., a polyethylene glycol having a molecular weight (“MW”) (or relative molar mass) of from 200 to 8000, e.g., MW 400 PEG dioleate; or MW600 PEG dioleate.

In certain implementations, the emulsifier is (or includes) a sorbitan fatty acid ester ethoxylate, e.g., polyoxyethylene (20) sorbitan tristearate, polyoxyethylene (20) sorbitan monooleate, polyoxyethylene (5) sorbitan monooleate, polyoxyethylene (20) sorbitan trioleate, or any combination thereof. For example, the sorbitan fatty acid ester can be a sorbitan tristearate, a sorbitan triolate, or any combination thereof.

In certain implementations, the emulsifier is (or includes) an alkyl phenol ethoxylate, a mixture of an ethoxylated alcohol and a glycerol oleate, or any combination thereof.

In certain implementations, the emulsifier is (or includes) a mixture of an ethoxylated alcohol and a glycerol oleate, e.g.: a C10 to C16 alcohol ethoxylate and a glycerol oleate combination; or polyoxyethylene lauryl ether, C10 to C16 alcohol ethoxylates, and glycerol oleate; or ethoxylated alcohols having primary C5-C20 carbon chains with an average of about 2 to about 7 ethoxylation groups, and a glycerol oleate; or a polyoxyethylene (11) C16-18 alcohol.

In certain implementations, the emulsifier is (or includes) a sorbitan tristearate.

Non-limiting examples of suitable emulsifiers include AL3149 (available from Croda), AL3313 (available from Croda), PC Emuls Green (available from Petro-Canada, Calgary, AB, Canada), Lutensol™ AT11 (available from BASF), SPAN65 (available from Uniqema), and S-MAZ™65 K (available from BASF).

[3]

In some implementations, the weight ratio of the paraffinic oil to the emulsifier is from about 10:1 to 500:1 (e.g., from 98:2 to 99.9:0.1, from 98:2 to 99.5:0.5). By way of example, the weight ratio of the paraffinic oil to the emulsifier can be about 95:5, 98:2, 98.5:1.5, 99:1, or 99.5:0.5.

[D] Pigment

The combination includes one or more) pigments. In some implementations, the pigment is a water-based pigment dispersion.

In some implementations, the pigment is an oil-based pigment dispersion.

In some implementations, the pigment is a phthalocyanine compound.

In certain implementations, the pigment is a metal-free phthalocyanine compound. In certain implementations, the pigment is a halogenated, metal-free phthalocyanine, e.g., a polychlorinated metal-free phthalocyanine.

In certain implementations, the pigment is a metal phthalocyanine compound.

In certain implementations, the pigment is a copper phthalocyanine.

In certain implementations, the copper phthalocyanine is a non-halogenated copper phthalocyanine, e.g., a nonchlorinated copper phthalocyanine. As an example, the pigment can be Phthalocyanine Blue BN (CAS 147-14-8).

In certain implementations, the copper phthalocyanine is a halogenated copper phthalocyanine. As an example, the pigment can be Phthalocyanine Green 6G (CAS 14302-13-7). As another example, the pigment can be polychlorinated (Cu II) phthalocyanine, such as Phthalocyanine Green G (CAS 1328-45-6 and 1328-53-6).

Non-limiting examples of suitable pigments include Sunsperse™ Green 7 (Pigment Green 7 dispersed in water, available from Sun Chemical Corp. Performance Pigments Cincinnati, Ohio, USA), Sunsperse™ EXP 006-102 and 006-95B (Pigment Green 7 dispersed in oil, available from Sun Chemical Corp. Performance Pigments, Cincinnati, Ohio, USA), and Pigment Green 7 powder (available from Hercules Exports, Mumbai, India).

[E] Silicone Surfactant

In some implementations, a silicone surfactant is included in the combination of paraffinic oil and pigment.

[1]

In some implementations, the silicone surfactant is (or includes) a silicone polyether.

In certain implementations, the silicone surfactant is (or includes) a silicone polyether having a suitable alkoxy group with hydrogen end groups (H-capped), methyl end groups (CH₃-capped), or acetyl end groups (COCH₃-capped). In certain implementations, the silicone surfactant is (or includes) a trisiloxane having a suitable alkoxy group with hydrogen end groups (H-capped), methyl end groups (CH₃-capped), or acetyl end groups (COCH₃-capped).

In certain implementations, the silicone surfactant is (or includes) a silicone polyether of the formula I:

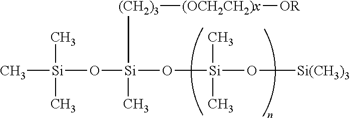

in which R is H, CH₃ or COCH₃; x is 1 to 24; and n is 0 or ≧1.

In certain implementations, the silicone surfactant is (or includes) a silicone polyether of the formula I wherein R=H; x=1 to 24; and n=0; e.g., a silicone polyether of the formula I wherein n=0; x=1-24; the average x=8-10; and R=H.

In certain implementations, the silicone surfactant is (or includes) a silicone polyether of the formula I wherein R=H; x=1 to 24; and n≧1.

In certain implementations, the silicone surfactant is (or includes) a silicone polyether of the formula I wherein R=CH₃; x=1 to 24; and n=0.

In certain implementations, the silicone surfactant is (or includes) a silicone polyether of the formula I wherein R=CH₃; x=1 to 24; and n≧1.

In certain implementations, the silicone surfactant is (or includes) a silicone polyether of the formula I wherein R=COCH₃; x=1 to 24; and n=0; e.g., a silicone polyether of the formula I wherein n=0; x=1-24, the average x=8-10; and R=COCH₃.

In certain implementations, the silicone surfactant is (or includes) a silicone polyether of the formula I wherein R=COCH₃; x=1 to 24; and n≧1.

In certain implementations, the silicone surfactant is (or includes) an H-capped dimethyl methyl (polyethylene oxide) silicone polymer; e.g., having a molecular weight (or relative molar mass) from 200 to 6000.

In certain implementations, the silicone surfactant is (or includes) a silicone polyether of the formula II:

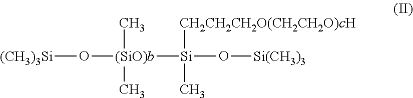

wherein c=2-16; and b=2-70. In certain implementations, the average b=44. In certain implementations, the average c=10. In certain implementations, the average b=44, and the average c=10.

In certain implementations, the silicone surfactant is (or includes) an H-capped trisiloxane, such as a silicone polyether of the formula III:

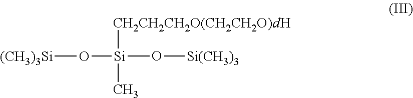

wherein d=1-24. In certain implementations, d=1-20. In certain implementations, the average d=8-10 (e.g., 8).

In certain implementations, the silicone surfactant is (or includes) a silicone copolyol, containing a hydrogen end group and one pendant polyethylene oxide group and has an average molecular weight between about 600 to about 1000 Daltons. In certain implementations, the silicone surfactant is (or includes) a trisiloxane with an ethoxylated alkyl group having a hydrogen end group (H-End); e.g., having a number of ethoxylation groups in the range of 1-20. In certain implementations, the silicone surfactant the silicone surfactant is (or includes) a methyl (propylhydroxide, ethoxylated) bis (trimethylsiloxy) silane; e.g., a dimethyl, methyl (polyethylene oxide) silicone polymer.

[2]

In some implementations, commercial preparations of the silicone surfactants can or can not contain small amounts of polyethylene glycols (PEG) or other low molecular weight polydimethyl siloxanes (PDMS).

In some implementations, the silicone surfactant further includes a polyethylene glycol.

In certain implementations, the polyethylene glycol is (or includes) a polyethylene glycol of the formula IV:

R¹—O—(CH₂CH₂O)_{f}—R²

wherein R¹=H or CH₂═CH—CH₂ or COCH₃; R²=H or CH₂═CH—CH₂ or COCH₃; and f≧1.

In certain implementations, the polyethylene glycol has a relatively low molecular weight, e.g. from 300 Daltons to 1500 Daltons. In certain implementations, the polyethylene glycol is a low molecular weight polyethylene glycol allyl ether, such as a low molecular weight polyethylene glycol mono-allyl ether having an average molecular of from about 300 to about 600 Daltons and having from 1 to 20 moles of ethylene glycol with an average ethylene oxide unit (EO) of 8 to 10.

In certain implementations, the polyethylene glycol is (or includes) a polyethylene glycol of the formula IV wherein R¹=CH₂═CH—CH₂, R²=H, and f=1-20 with an average f=8, a polyethylene glycol of the formula IV wherein R¹=CH₂═CH—CH₂ or COCH₃, and R²=COCH₃, a polyethylene glycol of the formula IV wherein R¹=CH₂═CH—CH₂, and R²=H, or any combination thereof.

In certain implementations, the polyethylene glycol is (or includes) a polyethylene glycol of the formula IV wherein R¹=CH₂═CH—CH₂ or COCH₃, and R²=COCH₃, a polyethylene glycol of the formula IV wherein R¹=CH₂═CH—CH₂, and R²=H, or any combination thereof.

In certain implementations, the polyethylene glycol is (or includes) a polyethylene glycol of the formula IV wherein R¹=CH₂═CH—CH₂, R²=H, and f=1-20 with an average f=8.

In certain implementations, the polyethylene glycol is (or includes) a polyethylene glycol of the formula IV wherein R¹=CH₂═CH—CH₂ or COCH₃, and R²=COCH₃.

In certain implementations, the polyethylene glycol is (or includes) a polyethylene glycol of the formula IV wherein R¹=CH₂═CH—CH₂, and R²=H.

Non-limiting examples of suitable polyethylene glycols can include Polyglykol A500 (available from Clariant).

In certain implementations, the silicone surfactant includes from 10 to 30 weight percent of a polyethylene glycol as described anywhere herein.

[3]

Non-limiting examples of suitable silicone surfactants can include Sylgard™ 309 (available from Dow Corning, Midland, Mich., USA), Silfsurf™ A008-UP (available from Siltech Corp. Toronto, ON, Canada), Lambent MFF 199 SW (available from Lambent Technologies Corp., Gurnee, Ill., USA), and Lambent MFF 159-100 (available from Lambent Technologies Corp., Gurnee, Ill., USA).

[F] Anti-Settling Agent

In some implementations, the combination can include one (or more) “anti-settling agents,” which can reduce the likelihood of having solids suspended in a dispersion from settling out under the influence of gravity.

In some implementations, the anti-setting agent is (or includes) a metal oxide and/or an organically modified clay.

In some implementations, the anti-setting agent is (or includes) a metal oxide.

In certain implementations, the anti-setting agent is (or includes) a fumed metal oxide and/or a precipitated metal oxide.

In certain implementations, the anti-setting agent is (or includes) one or more of the following forms of silica: precipitated silica (e.g., an untreated, precipitated silica) or fumed silica (e.g., an untreated, fumed silica). As used herein, the term “untreated fumed silica”, or the like, is used to refer to a hydrophilic fumed silica. As used herein, the term “treated fumed silica”, or the like, is used to refer to a hydrophobic fumed silica.

In some implementations, the anti-settling agent is (or includes) an organically modified clay. In certain implementations, the anti-setting agent is (or includes) one or more of the following organically modified clays: an organically modified smectite clay, an organically modified hectorite clay, an organically modified bentonite clay, an organically modified montmorillonite clay and an organically modified attapulgite clay.

In certain implementations, the organically modified clay is activated by a chemical activator.

In certain implementations, the chemical activator includes a low-molecular-weight polar organic compound, e.g., a least one compound selected from the group consisting of a low-molecular weight ketone, a low-molecular weight alcohol and propylene carbonate.

In certain implementations, the chemical activator includes water and at least one compound selected from the group consisting of a low-molecular weight ketone, a low-molecular weight alcohol and propylene carbonate.

In certain implementations, the chemical activator includes a low-molecular weight ketone; or a low-molecular weight ketone and water (such as a low molecular weight ketone and water in a weight ratio of 95/5). An example of a low-molecular weight ketone is acetone.

In certain implementations, the chemical activator includes a low-molecular weight alcohol; or a low-molecular weight alcohol and water (such as a low-molecular weight alcohol and water in a weight ratio of 95/5). Examples of low-molecular weight alcohols include methanol or ethanol.

In certain implementations, the chemical activator includes propylene carbonate; or propylene carbonate and water (such as, propylene carbonate and water in a weight ratio of 95/5).

[G] Water

In some implementations, the combinations can further include water.

In some implementations, the pigment is dispersed in water before it is added to the remaining components of the combination (typically water is 1:1 weight percent with with pigment), resulting in, e.g., the presence of 3 parts per weight of water in the combination.

In some implementations, the combinations can further include water, e.g., as a diluent, e.g., as a diluent added prior to application of the combinations to a plant (e.g., a turfgrass).

In some implementations, the combinations can further include both sources of water described above.

In some implementations the water is distilled water and/or other waters having a low mineral electrolyte content.

[H] Other Components

In some implementations, the combinations further include one or more other components that are customary additives or adjuvants for the preparation of compositions in the field of plant treatments and/or components that are inert (e.g., may not materially affect the activity and/or overall performance of the combinations) and/or one or more other active components. As an example, the combinations can further include customary additives or adjuvants that can be present in a commercially available conventional chemical pesticide or growth regulators.

[I] Conventional Chemical Fungicides and Growth Regulators

[1]

In some implementations, the conventional fungicide is a DMI fungicide.

In certain implementations, the DMI fungicide is at least one fungicide selected from the group consisting of tetraconazole, tebuconazole, propioconazole, azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, prothioconazole, simeconazole, triadimefon, triadimenol, triticonazole, imazalil, oxpoconazole, pefurazoate, prochloraz, triflumizole, fenarimol, nuarimol, triforine, and pyrifenox.

In certain implementations, the DMI fungicide is at least one fungicide selected from the group consisting of tetraconazole, tebuconazole, and propioconazole. Tetraconazole can be obtained commercially, for example, as a product identified as Domark™ (available from Valent). Tebuconazole can be obtained commercially, for example, as a product identified as Folicur™ (available from Bayer Crop Science). Propioconazole can be obtained commercially, for example, in the product identified as Quilt™ (available from Syngenta).

In other implementations, the DMI fungicides described herein can be synthesized using conventional techniques known in the art of synthetic organic chemistry.

[2]

In some implementations, the conventional fungicide is a QoI fungicide.

In certain implementations, the QoI fungicide is at least one fungicide selected from the group consisting of pyraclostrobin, azoxystrobin, fluoxastrobin, trifloxystrobin, coumoxystrobin, dimoxystrobin, enoxastrobin, famoxadone, fenamidone, fenaminostrobin, flufenoxystrobin, kresoxim-methyl, metominostrobin, orysastrobin, pyraoxystrobin picoxystrobin, pyrametastrobin, pyribencarb, and triclopyricarb.

In certain implementations, the QoI fungicide is at least one fungicide selected from the group consisting of pyraclostrobin, azoxystrobin, fluoxastrobin, and trifloxystrobin.

In certain implementations, the QoI fungicide is at least one fungicide selected from the group consisting of pyraclostrobin and azoxystrobin.

In certain implementations, the QoI fungicide is methyl (2E)-2-{2-[(3-butyl-4-methyl-2-oxo-2H-chromen-7-yl)oxymethyl]phenyl}-3-methoxyacrylate (coumoxystrobin): CAS No. 850881-70-8.

In certain implementations, the QoI fungicide is (E)-2-(methoxyimino)-N-methyl-2-[α-(2,5-xylyloxy)-o-tolyl]acetamide (dimoxystrobin): CAS No. 149961-52-4.

In certain implementations, the QoI fungicide is enoxastrobin. In alternative implementations, the QoI fungicide can be, for example, (RS)-3-anilino-5-methyl-5-(4-phenoxyphenyl)-1,3-oxazolidine-2,4-dione (famoxadone): CAS No. 131807-57-3.

In certain implementations, the QoI fungicide is (S)-1-anilino-4-methyl-2-methylthio-4-phenylimidazolin-5-one (fenamidone): CAS No. 161326-34-7.

In certain implementations, the QoI fungicide is fenaminostrobin.

In certain implementations, the QoI fungicide is flufenoxystrobin.

In certain implementations, the QoI fungicide is methyl (E)-methoxyimino[α-(o-tolyloxy)-o-tolyl]acetate (kresoxim-methyl): CAS No. 143390-89-0.

In certain implementations, the QoI fungicide is (E)-2-(methoxyimino)-N-methyl-2-(2-phenoxyphenyl)acetamide (metominostrobin): CAS No. 133408-50-1.

In certain implementations, the QoI fungicide can be, for example, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide (orysastrobin): CAS No. 248593-16-0.

In certain implementations, the QoI fungicide is methyl (2E)-2-(2-{[3-(4-chlorophenyl)-1-methylpyrazol-5-yl]oxymethyl}phenyl)-3-methoxyacrylate (pyraoxystrobin): CAS No. 862588-11-2.

In certain implementations, the QoI fungicide is methyl (2E)-3-methoxy-2-{2-[6-(trifluoromethyl)-2-pyridyloxymethyl]phenyl}acrylate (picoxystrobin): CAS No. 117428-22-5.

In certain implementations, the QoI fungicide is pyrametastrobin.

In certain implementations, the QoI fungicide is methyl {2-chloro-5-[(1E)-1-(6-methyl-2-pyridylmethoxyimino)ethyl]benzyl}carbamate (pyribencarb): CAS No. 799247-52-2.

In certain implementations, the QoI fungicide is triclopyricarb.

In certain implementations, the QoI fungicide is carbamic acid, [2-[[[1-(4-chlorophenyl)-1H-pyrazol-3-yl]oxy]methyl]-phenyl]methoxy-, methyl ester (pyraclostrobin). Pyraclostrobin can be commercially available, for example, as a product identified as Insignia™ (available from BASF Corporation, 26 Davis Drive, Research Triangle Park, N.C. 27709).

In certain implementations, the QoI fungicide is methyl (E)-2-{2-[6-(2-cyano-phenoxy)pyrimidin-4-yloxy]phenyl}-3-m ethoxy-acrylate (azoxystrobin). Azoxystrobin™ can be commercially available, for example, as a product identified as Heritage™ (available from Syngenta Crop Protection, Inc., Greensboro, N.C. 27409).

In certain implementations, the QoI fungicide is [(1E)-[2-[[6-(2-chlorophenoxy)-5-fluoro-4-pyrimidinyl]oxy]phenyl]5,6-dihydro-1,4,2-dioxazin-3-yl]methanone-O-methyloxime] (fluoxastrobin). Fluoxastrobin can be commercially available, for example, as a product identified as Disarm™ (available from Arysta LifeScience North America, LLC, 15401 Weston Parkway, Suite 150, Cary, N.C. 27513).

In certain implementations, the QoI fungicide is benzeneacetic acid, (E,E)-alpha-(methoxyimino)-2((((1-(3-trifluoromethyl)phenyl)ethylidene)-amino)oxy)methyl)-, methyl ester (trifloxystrobin). Trifloxystrobin can be commercially available, for example, as a product identified as Compass™ (available from Bayer Environmental Science, 2T. W. Alexander Drive, Research Triangle Park, N.C. 27709).

In other implementations, the QoI fungicides described herein can be synthesized using conventional techniques known in the art of synthetic organic chemistry.

Plant Growth Regulators

In some implementations, the combination can further include one or more other growth regulators that are customary for the preparation of compositions in the field of plant treatments. As an example, the combinations can further include customary additives or adjuvants that can be present in a commercially available conventional chemical pesticide.

In some implementations, the combinations include only combinations of the components set forth is sections [B] through [I] above.

II. Non-Limiting Combinations of Components

[A] Combinations that Include a Single Composition

[1]

In some implementations, the combinations can be in the form of a single composition (e.g., contained within a storage pack or a vessel suitable for applying the composition to a plant, e.g., turf grass). These compositions are sometimes referred to herein (without limitation, e.g., as to quantity or application mode) as a 1-pack formulations or concentrates in the absence of water for dilution.

(i) In some implementations, the composition includes one (or more) paraffinic oils, which can include any one or more of the features described in any one or more of sections [I][B][1], [I][B][2], and [I][B][3] above and one (or more) pigments which can include any one or more of the features described in [I][D] above.

In some implementations, the combination further includes (but is not limited to) one or more of the following:

(ii) one (or more) conventional chemical fungicides, which can include any one or more of the features described in any one or more of sections [I][I][1] and/or [I][I][2] (e.g., one or more DMI fungicides and/or one or more QoI fungicides);

(iii) one (or more) emulsifiers, which can include any one or more of the features described in any one or more of sections [I][C][1], [I][C][2], and [I][C][3] above;

(iv) [Intentionally left blank]

(v) one (or more) silicone surfactants, which can include any one or more of the features described in any one or more of sections [I][E][1], [I][E][2], and [I][E][3] above;

(vi) one (or more) anti-settling agents, which can include any one or more of the features described in section [I][F] above; and

(vii) one (or more) components described in section [I][H].

In some implementations, the composition includes (i) and (iii).

In some implementations, the composition includes (i), (iii), and (v).

In some implementations, the composition includes (i), (iii), (v), and (vi).

In some implementations, the composition includes (i), (ii), and (iii).

In some implementations, the composition includes (i), (ii), (iii), and (v).

In some implementations, the composition includes (i), (ii), (iii), (v), and (vi).

[2] Concentrates

In some of the implementations described in section [II][A][1], one or more of the following applies:

(2-a) the weight ratio of paraffinic oil to the emulsifier is from about 10:1 to 500:1 (e.g., from 45:1 to 55:1, e.g., 49:1, 50:1);

(2-b) the weight ratio of paraffinic oil to the pigment is from about 5:1 to 100:1 (e.g., from 25:1 to 35:1, e.g., 28:1, 30:1);

(2-c) the weight ratio of pigment to the silicone surfactant is from about 2:1 to 50:1 (e.g., from 3:1 to 6:1, e.g., 4.5:1);

(2-d) the weight ratio of paraffinic oil to the conventional chemical fungicide (e.g., one or more DMI fungicides and/or one or more QoI fungicides) is from about 2:1 to 10000:1 (e.g., from 100:1 to 160:1; from 90:1 to 120:1, e.g., 111:1, 110:1; from 130:1 to 150:1, e.g., 139:1, 140:1).

In certain implementations, (2-a) applies; or (2-a), (2-b) and (2-c) apply; or (2-b), and (2-c) apply. In certain implementations, (2-d) further applies to any one of the above-listed combinations of (2-a), (2-b) and (2-c).

In some of the implementations described in section [II][A][1], one or more of the following applies:

(2-aa) the concentrate includes from 50 to 300 parts per weight (e.g., 200-300, e.g., 260; e.g., 50-150, e.g., 100) parts per weight of the paraffinic oil;

(2-bb) the concentrate includes from 1 to 10 parts per weight (e.g., 3-7, e.g., 5; e.g., 1-5, e.g., 1.9, e.g., 2) parts per weight of the emulsifier;

(2-cc) the concentrate includes from 1 to 15 parts per weight (e.g., 7-11, e.g., 9; e.g., 2-5, e.g., 3.5) parts per weight of the pigment;

(2-dd) the concentrate includes from 0.1 to 10 parts per weight (e.g., 0.5-1, e.g., 0.8, e.g., e.g., 2-5, e.g., 3.1) parts per weight of the silicone surfactant;

(2-ee) the concentrate includes from 0.5 to 20 parts per weight (e.g., 6-10, e.g., 8; e.g., 2-5, e.g., 3.1) parts per weight of the anti-settling agent; or

(2-ff) the concentrate includes from 0.01 to 10 parts per weight (e.g., 0.5-1, e.g., 0.8, e.g., e.g., 1-3, e.g., 2) parts per weight of the conventional chemical fungicide.

In certain implementations, (2-aa) and (2-bb) apply; or (2-cc) and (2-dd) apply; or (2-aa), (2-bb), and (2-ff) apply; or (2-cc), (2-dd), and (2-ff) apply; or (2-aa), (2-bb), (2-cc), and (2-dd) apply, or (2-aa), (2-bb), (2-cc), (2-dd), and (2-ff) apply. In certain implementations, (2-ee) further applies to each of the above-listed implementations.

In some implementations, any one or more of the features described in one or more of (2-a) and (2-d) can be combined with any one or more of the features described in one or more of (2-aa) and (2-ff).

In some implementations, the pigment is dispersed in compatible oil, e.g., a paraffinic oil. In some implementations, the pigment is dispersed in the same paraffinic oil as is used to provide the properties as described herein, for addition to the other components of the combinations described herein. In certain implementations, a silicone surfactant and/or emulsifier and/or anti-settling agent can be included, e.g., to stabilize the pigment in the oil-based combination.

For example, polychlorinated Cu (II) phthalocyanine can be dispersed in a paraffinic oil, such as N65DW (available from Petro-Canada) to provide about 18% polychlorinated CU (II) phthalocyanine (SUNSPERSE® EXP 006-102, available from Sun Chemical Corp. Performance Pigments, Cincinnati, Ohio USA) prior to mixing with the remaining components. In certain implementations, a silicone surfactant and/or emulsifier and/or anti-settling agent can be included. While not wishing to be bound by theory, it is believed that the addition of these components can provide an intermolecular hydrophilic and lipophilic balance within the combination so as to substantially prevent the polychlorinated Cu (II) phthalocyanine from separating out of suspension during application, e.g., to a turf grass.

In some of the implementations described in section [II][A][1], the combination includes the components present in the Civitas™ 1-pack available from Petro-Canada.

[3]

In some of the implementations described in sections [II][A][1] and [II][A][2], the composition further includes water. In certain implementations, weight percent ratio of the undiluted composition to water is from about 1:1 to 1:100 (e.g., from 1-50, 1-30, 1-20, 1-15). In certain implementations, the weight percent of the paraffinic oil in the diluted compositions is from about 2-50 weight percent (e.g., 15%). In certain implementations, the composition is in the form of an oil in water emulsion as described anywhere herein.

In some implementations, the pigment is dispersed in water for addition to the other components of the combinations described herein. In certain implementations, a silicone surfactant and/or emulsifier and/or anti-settling agent can be included, e.g., to stabilize the pigment in the oil/water-based combination.

For example, polychlorinated Cu (II) phthalocyanine can be dispersed in a water to provide about 40% polychlorinated CU (II) phthalocyanine (SUNSPERSE® GREEN 7, available from Sun Chemical Corp. Performance Pigments, Cincinnati, Ohio USA) prior to mixing with the remaining components. In certain implementations, a silicone surfactant and/or emulsifier and/or anti-settling agent can be included. While not wishing to be bound by theory, it is believed that the addition of these components can provide an intermolecular network so as to substantially prevent the polychlorinated Cu (II) phthalocyanine from separating out of suspension during application, e.g., to a turf grass.

[B] Combinations that Include Two or More Compositions

[1]

In some implementations, the combinations include two or more separately contained (e.g., packaged) compositions, each containing one or more of the components described in sections [I][B]-[I][F] and [I][H] and [I][I]. These implementations are sometimes referred to (as appropriate and without limitation, e.g., as to quantity or application mode) as 2-pack and 3-pack formulations, compositions, or concentrates in the absence of water for dilution.

In some implementations, the combination includes a first and separately contained “Composition X” and a second and separately contained “Composition Y”, in which:

(1) the first and separately contained Composition X includes:
one (or more) paraffinic oils, which can include any one or more of the features described in any one or more of sections [I][B][1], [I][B][2], and [I][B][3] above;
one (or more) emulsifiers, which can include any one or more of the features described in any one or more of sections [I][C][1], [I][C][2], and [I][C][3] above; and

(2) the second and separately contained Composition Y includes:
one (or more) pigments, which can include any one or more of the features described in section [I][D] above and
one (or more) silicone surfactants, which can include any one or more of the features described in any one or more of sections [I][E][1], [I][E][2], and [I][E][3] above.

In some implementations, the combinations include a first and separately contained Composition X and a second and separately contained Composition Y, in which:

(1) the first and separately contained Composition X includes:
one (or more) paraffinic oils, which can include any one or more of the features described in any one or more of sections [I][B][1], [I][B][2], and [I][B][3] above;
one (or more) emulsifiers, which can include any one or more of the features described in any one or more of sections [I][C][1], [I][C][2], and [I][C][3] above;
one (or more) pigments, which can include any one or more of the features described in section [I][D] above;
one (or more) silicone surfactants, which can include any one or more of the features described in any one or more of sections [I][E][1], [I][E][2], and [I][E][3] above; and
one (or more) anti-settling agents, which can include any one or more of the features described in section [I][D] above; and

(2) the second and separately contained Composition B includes:
one (or more) conventional chemical fungicides, which can include any one or more of the features described in any one or more of sections [I][I][1] and/or [I][I][2] (e.g., one or more DMI fungicides and/or one or more QoI fungicides).

In some implementations, the Combinations include a first and separately contained Composition X and a second and separately contained Composition Y, in which:

(1) the first and separately contained Composition X includes:
one (or more) paraffinic oils, which can include any one or more of the features described in any one or more of sections [I][B][1], [I][B][2], and [I][B][3] above; and
one (or more) emulsifiers, which can include any one or more of the features described in any one or more of sections [I][C][1], [I][C][2], and [I][C][3] above;

(2) the second and separately contained Composition Y includes:
one (or more) conventional chemical fungicides, which can include any one or more of the features described in any one or more of sections [I][A][1] and/or [I][A][2] (e.g., one or more DMI fungicides and/or one or more QoI fungicides);
one (or more) pigments, which can include any one or more of the features described in section [I][D] above; and
one (or more) silicone surfactants, which can include any one or more of the features described in any one or more of sections [I][E][1], [I][E][2], and [I][E][3] above.

In some implementations, the combinations include a first and separately contained Composition X and a second and separately contained Composition Y, in which:

(1) the first and separately contained Composition X includes:
one (or more) paraffinic oils, which can include any one or more of the features described in any one or more of sections [I][B][1], [I][B][2], and

[I][B][3] above;
one (or more) emulsifiers, which can include any one or more of the features described in any one or more of sections [I][C][1], [I][C][2], and [I][C][3] above; and
one (or more) conventional chemical fungicides, which can include any one or more of the features described in any one or more of sections [I][I][1] and/or [I][I][2] (e.g., one or more DMI fungicides and/or one or more QoI fungicides).

(2) the second and separately contained Composition Y includes:
one (or more) pigments, which can include any one or more of the features described in section [I][D] above; and
one (or more) silicone surfactants, which can include any one or more of the features described in any one or more of sections [I][E][1], [I][E][2], and [I][E][3] above.

In some implementations, the combinations include a first and separately contained Composition X, a second and separately contained Composition Y, and a third and separately contained Composition Z, wherein:

(1) the first and separately contained Composition X includes:
one (or more) paraffinic oils, which can include any one or more of the features described in any one or more of sections [I][B][1], [I][B][2], and [I][B][3] above; and
one (or more) emulsifiers, which can include any one or more of the features described in any one or more of sections [I][C][1], [I][C][2], and [I][C][3] above; and

(2) the second and separately contained Composition Y includes:
one (or more) pigments, which can include any one or more of the features described in section [I][D] above and
one (or more) silicone surfactants, which can include any one or more of the features described in any one or more of sections [I][E][1], [I][E][2], and [I][E][3] above; and

(3) the third and separately contained Composition Z includes:
one (or more) conventional chemical fungicides, which can include any one or more of the features described in any one or more of sections [I][I][1] and/or [I][I][2] (e.g., one or more DMI fungicides and/or one or more QoI fungicides). [2] Component Amounts in Combinations Having Two or More Composition (Concentrates)

In some of the implementations described in section [II][B][1], one or more of the following applies:

(2-aaa) the weight ratio of paraffinic oil to the emulsifier is from about 10:1 to 500:1 (e.g., from 45:1 to 55:1, e.g., 49:1, 50:1);

(2-bbb) the weight ratio of paraffinic oil in a composition to the pigment (in the same or a different composition) is from about 5:1 to 100:1 (e.g., from 25:1 to 35:1, e.g., 28:1, 30:1);

(2-ccc) the weight ratio of pigment to the silicone surfactant is from about 2:1 to 50:1 (e.g., from 3:1 to 6:1, e.g., 4.5:1);

(2-ddd) the weight ratio of paraffinic oil in a composition to the weight ratio of paraffinic oil to the conventional chemical fungicide (e.g., one or more DMI fungicides and/or one or more QoI fungicides) in the same or a different composition is from about 2:1 to 10,000:1 (e.g., from 100:1 to 160:1; from 90:1 to 120:1, e.g., 111:1, 110:1; from 130:1 to 150:1, e.g., 139:1, 140:1).

In certain implementations, (2-aaa) applies; or (2-aaa), (2-bbb) and (2-ccc) apply; or (2-bbb), and (2-ccc) apply. In certain implementations, (2-ddd) further applies to any one of the above-listed combinations of (2-aaa), (2-bbb) and (2-ccc).

In some of the implementations described in section [II][B][1], one or more of the following applies:

(2-aaaa) the composition (concentrate) includes from about 50 to 300 parts per weight (e.g., 100) parts per weight of the paraffinic oil;

(2-bbbb) the composition (concentrate) includes from about 1 to 10 parts per weight (e.g., 1.9, e.g., 2) parts per weight of the emulsifier;

(2-cccc) the composition (concentrate) includes from about 1 to 10 parts per weight (e.g., 3.5) parts per weight of the pigment;

(2-dddd) the composition (concentrate) includes from about 0.1 to 10 parts per weight (e.g., 0.8) parts per weight of the silicone surfactant;

(2-eeee) the composition (concentrate) includes from about 0.5 to 20 parts per weight (e.g., 3.1) parts per weight of the anti-settling agent; or

(2-ffff) the composition (concentrate) includes from about 0.01 to 10 parts per weight (e.g., 0.8) parts per weight of the conventional chemical fungicide (e.g., one or more DMI fungicides and/or one or more QoI fungicides).

In certain implementations, (2-aaaa) and (2-bbbb) apply; or (2-aaaa) through (2-eeee) apply; or (2-ffff) applies; or (2-cccc), (2-dddd), and (2-ffff) apply; or (2-cccc) and (2-dddd) apply.

In certain implementations, (2-aaaa) through (2-eeee) apply in a composition (concentrate), and (2-ffff) applies in another composition (concentrate).

In certain implementations, (2-aaaa) and (2-bbbb) apply in a composition (concentrate), and (2-cccc), (2-dddd), and (2-ffff) apply in another composition (concentrate).

In certain implementations, (2-aaaa) and (2-bbbb) apply in a composition (concentrate), and (2-cccc) and (2-dddd) apply in another composition (concentrate).

In certain implementations, (2-aaaa) through (2-eeee) apply in a composition (concentrate), (2-cccc) and (2-dddd) apply in a second composition (concentrate), and (2-ffff) applies in a third composition (concentrate).

In some implementations, any one or more of the features described in one or more of (2-aaa) and (2-ddd) can be combined with any one or more of the features described in one or more of (2-aaaa) and (2-ffff).

In some of the implementations described in section [II][B][1], the second composition can further include water (e.g., resulting in a dispersion of the pigment in the water).

In some of the implementations described in section [II][B][1], the first and second composition include the components present in Civitas™ 2-pack (Civitas™ and Harmonizer™ 16:1) available from Petro-Canada.

[3]

In some of the implementations described in sections [II][B][1] and [II][B][2], each of the compositions, independently, further includes water. In certain implementations, the combination of compositions (concentrates) described above are combined and diluted with water (e.g., spray volume of the diluted end product is about 5 to 50 gal/acre, e.g., 10 to 20 gal/acre). In certain implementations, oil in the end product is from about 80 to 640 oz/acre (other components can be calculated based on ratio with oil).

[C] As the skilled artisan will appreciate, the weight percent of a given component(s) can vary, e.g., due to dilution with water or whether the combination is in the form of a single composition or two or more separately contained compositions. In some implementations, the weight ratio of any two or more components is essentially the same regardless of whether the combination is in the form of a single composition (diluted with water or undiluted) or in the form two or more separately contained compositions (diluted with water or undiluted). In the latter case, this can be achieved by adjusting the component amounts in each of the separately contained compositions to match, for example, a weight percent ratio employed in single composition combination.

III. Application of Combinations

In general, the combinations can be applied to the plant by conventional methods known in the art, e.g., spraying, misting, sprinkling, pouring, or any other suitable method. The compositions can be reapplied as required. The combination can be applied by soil drenching, can be applied to the foliage or can be applied by both soil drenching and foliar application.

In some implementations, the combinations include both paraffinic oil and water. It is advantageous to apply such combinations as oil-in-water (O/W) emulsions. In some implementations, an oil-in-water emulsion is prepared by a process that includes combining the paraffinic oil, water, and any other components and the paraffinic oil and applying shear until the emulsion is obtained. In other implementations, an oil-in-water emulsion is prepared by a process that includes combining the paraffinic oil, water, and any other components at the nozzle of a spray gun.

In other implementations, the combinations can include two or more separately contained (e.g., packaged) compositions, each containing one or more of the above-mentioned components. Said compositions can be combined and applied to a plant with or without prior dilution with water; or each composition can be applied separately to the same plant either simultaneously or sequentially, and each independently applied with or without prior dilution with water.

In the above-described implementations, application of any one (or more) compositions/combinations can be applied as follows:

The combinations can be applied to the soil and/or to the leaves and/or stems of the plants.

The combinations can be applied to the root tissues.

The combinations can be applied by pouring and/or root bathing.

The combinations can be applied over a time period of at least ten seconds (e.g., at least five seconds, at least two seconds).

The combinations can be applied by soil drenching.

The combinations can be applied by drip irrigation.

The combinations can be applied by soil injection.

The combinations can be applied by spraying the leaves and/or stems to run-off.

The combinations can be applied by tray soak.

In the above-described implementations, application of any one (or more) compositions can be repeated one or more times.

In some implementations, any one or more of the following can apply:
the combination can be applied to the plant prior to the stress condition, prior to the plant showing symptoms of stress, or prior to significant deterioration of the plant due to the stress at a rate from 20 to 640 oz/acre (e.g., from 25 oz/acre to 400 oz/acre);
the combination can be applied to the plant prior to the stress condition, prior to the plant showing symptoms of stress, or prior to significant deterioration of the plant due to the stress 1 to 10 times during growing season until harvest, with intervals greater than one days;
the combination can be applied prior to the plant showing symptoms of stress, or prior to significant deterioration of the plant due to the stress 1 to 10 times prior to the onset of abiotic stress such as cold, drought, heat, salt, shade, excess of water, and nutrition stress, with intervals greater than one day;
the combination can be applied to the plant prior to the plant showing symptoms of stress, or prior to significant deterioration of the plant due to the stress 1 to 10 times at the onset of abiotic stress such as cold, drought, heat, salt, shade, excess of water and nutrition stress, with intervals greater than one day;
the paraffinic oil is used or applied to the plant 1 to 10 times prior to the dormancy season (e.g. after the harvesting season in the fall), with intervals greater than one day.

In some implementations, the combinations described herein can be prepared using the methods described in, for example, WO 2009/155693.

The features described in section III above can be combined with any one or more of the features described in sections I and II above.

Various alternative implementations and examples are described herein. These implementations and examples are illustrative, and not limiting.

### EXAMPLES

The following abbreviations are used throughout the examples:

“Composition A”: Paraffinic oil, having a composition of 98% Isoparaffin

“Composition B”: 40% polychlorinated Cu(II) phthalocyanine dispersed in water

“Composition C”: Combination of Paraffinic oil and polychlorinated Cu(II) phthalocyanine dispersed in water in a ratio of 30:1, having 90% isoparaffin and 2.4% polychlorinated CU(II) phthalocyanine, unless otherwise indicated.

### Example 1

### Effect of a Combination of Compositions A and B on Winter Cold Hardiness on Fruit Trees

Materials and Methods

The ability of a combination of Compositions A and B to improve cold hardiness in fruit trees was studied in 25 peach trees (cv. Elberta) and 25 apple trees (cv. Jonagold) from fall (October) to the following spring (March). Trees were grown in #3 (10 L) containers in a standard nursery mix of pine bark, peat moss, and sand. Mean tree heights (±standard error) were 1.87 m (0.01 m) for the apple trees and 1.55 m (0.02 m) for the peach trees. Mean stem calipers (15 cm above soil line) were 21.0 cm (0.35 cm) and 17.0 cm (0.26 cm) for the apple and peach trees, respectively. Trees were in full leaf when the study started, and all trees appeared healthy and vigorous.

Five trees from each species were randomly assigned to one of five treatment protocols, based on application type (foliar or soil drench) and treatment schedule (Table 1). Treatment application dates were October 3, October 18, and November 5. On each treatment date, isoparaffin was mixed in 5 gal (18.9 L) carboys. For the soil drench, 2 L of product was applied to the soil surface. Relatively little product (<10% of amount applied) ran through the bottom of the containers following soil drench. For the foliar application, the composition in the carboys was diluted with a further amount of water (1 part product: 3 parts water) in a graduated cylinder and poured into a 1 gal (3.7 L) pump-up sprayer. Trees that received the foliar treatment were separated from the remaining trees to avoid drift of the foliar spray treatment to other treatment groups. All leaves and stems receiving the foliar spray treatment were sprayed until run-off was observed.

TABLE 1
Isoparaffin application methods, rates and timing

| | | | | Application dates | | |
|---|---|---|---|---|---|---|
| | Products | | Application | Early | Mid | Early |
| Application type | Composition A | Composition B | rate | October | October | November |
| Soil drench | 9.40% | 0.60% | 2 L | X | X | X |
| Foliar | 2.35% | 0.15% | To run-off | X | X | X |
| Soil drench | 9.40% | 0.60% | 2 L | X | X | X |
| +foliar | 2.35% | 0.15% | To run-off | X | X | X |
| Soil drench | 9.40% | 0.60% | 2 L | X | | |
| +delayed foliar | 2.35% | 0.15% | To run-off | | | X |
| Control | | | | | | |

Following application of a combination of Compositions A and B, shoot samples were collected on four separate dates, and shoot samples from each date were assessed for cold-hardiness conducted by exposing each shoot to a range of controlled freeze conditions.

Samples for cold hardiness testing were collected on November 28, (apple and peach), January 3, (apple and peach), February 7, (apple), and March 14 (apple) of the following year. Peach shoots were not available for sampling on the February and March test dates. For each shoot sample collection, three or four 12-15 cm stem segments were collected from each tree. The samples were brought into the lab and cut in 3 cm segments. One segment from each tree was laid out on a piece of masking tape, covered with damp cheesecloth and then wrapped in aluminum foil. For each species, 12 or 13 ‘bundles’ were assembled, which each contained one sample from each tree (25 samples per bundle).

All of the sample bundles, except controls, were placed in a programmable freezer. The samples were initially held at 0° C. overnight, and then the freezer temperature was ramped down at 3° C. h⁻¹ to reach test temperatures between −6° C. and −42° C. (Table 2).

When sample temperatures reached a given test temperature, one bundle of each species was removed from the freezer. Once the samples were removed from the freezer they were placed in a walk-in cooler (4° C.) and allowed to slowly thaw. After the samples thawed they were placed in an incubation chamber at room temperature (22° C.) for 5 days. Samples were subsequently scored by removing the outer epidermis and examining periderm tissue. Samples were scored as 1 (no damage), 0.5 (some browning), or 0 (dead).

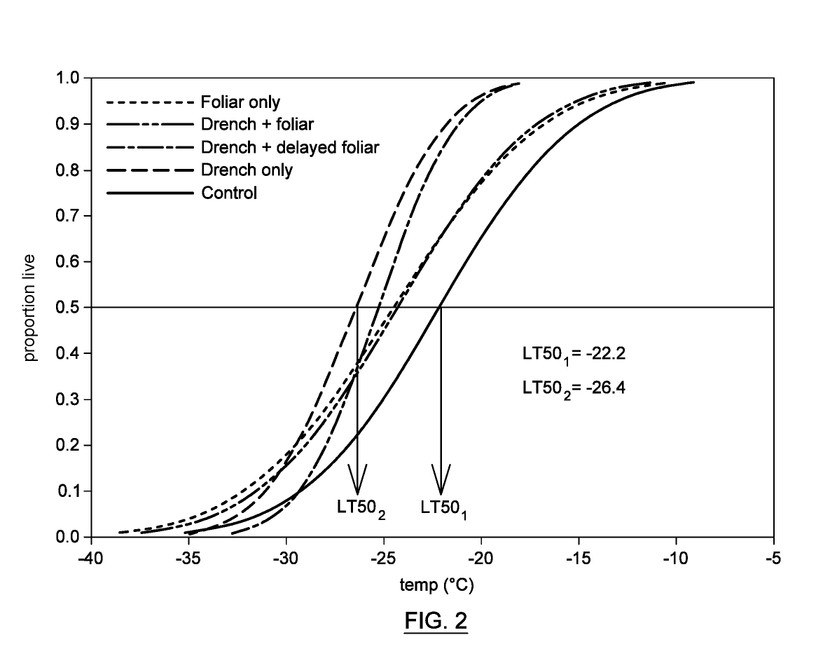

Data were analyzed by fitting a normal distribution function to the damage code and test temperature data using the PROC PROBIT procedure in SAS. Output from this analysis allows for estimation of an LT₅₀ (Lethal Temperature 50%), the predicted temperature when 50% of samples were killed (see FIG. 2).

Results

Cold hardiness (LT₅₀) varied between species and among dates and treatments (Table 3). Apple trees reached maximum hardiness (lowest LT₅₀) in February, while peach trees reached maximum hardiness in January.

For apple trees, all of the treatments that included a soil drench application increased (p<0.1) hardiness from the first (November) evaluation date. The foliar only treatment also increased cold hardiness of apple trees during January and February. The largest increase in hardiness relative to the untreated control trees was 4.2° C. in November for apple trees treated with a soil drench.

Peach trees were less cold hardy overall than apple trees and were generally less responsive to the treatments (Table 3). An exception to this were peach trees treated with the soil drench+delayed foliar application, which increased cold hardiness by 5.7° C. in January.

TABLE 3
Cold hardiness (LT₅₀ in ° C.) of apple
and peach trees treated with isoparaffin
Apple

| | Sample date | | | |
|---|---|---|---|---|
| Treatment¹ | November | January | February | March |
| Drench only | −26.4 | −23.3 | −30.1 | −20.4 |
| Drench + delayed | −25.3 | −22.0 | −28.9 | −18.4 |
| foliar | | | | |
| Drench + foliar | −24.3 | −23.5 | −31.1 | −18.9 |
| Foliar only | −24.5 | −25.6 | −30.9 | −18.4 |
| Control | −22.2 | −21.7 | −28.7 | −17.7 |

Peach

Sample date

| Treatment | November | January |
|---|---|---|
| Drench only | −18.8 | −22.1 |
| Drench + delayed foliar | −20.9 | −24.5 |
| Drench + foliar | −17.7 | −20.9 |
| Foliar only | −18.6 | −20.6 |
| Control | −18.5 | −18.8 |

Conclusions

Generally, soil drench application of the combination of Composition A and Composition B increased cold hardiness by 2-4° C. or more in apple and peach trees in January. While peach shoots were not available for testing in March and April, the results from apple trees suggests that application of a combination of Composition A and Composition B improves cold hardiness through the winter.

### Example 2

### Effect of Combination of Composition a and Composition B on Drought Tolerance of Wheat Under Terminal Drought Conditions

Terminal drought refers to drought conditions at the end of wheat growing stage, i.e. after flowering.

Materials and Methods

Plant materials: Two hard white spring wheat lines IDO377S12 and M12013 were used in this study.

Field condition: The two lines were planted as two borders in F311 in Aberdeen, Id., USA. Water was applied weekly until early grain filling stage. No other chemical treatments were applied during growth stages.

Two treatments of the combination of Composition A and Composition B with different spraying rates plus one control were set in the field (Table 4). Each treatment had three replicates (plots). The chemicals (A: Composition A, B: Composition B) were applied in two stages: once at the flag leaf stage (Feeks 8.0) and once at the flowering stage (Feeks 10.5). Spray volume is 20 gallon/acre.

TABLE 4
Spraying rate (oz/acre) of three treatments at different growth stages

| Treatment | Chemical | Flag leaf (F8) | Early flowering (F10.5) |
|---|---|---|---|
| Control | Untreated | 0 | 0 |
| T1 | (A) + (B) | A/320 oz + B/20 oz | A/160 oz + B/10 oz |
| T2 | (A) + (B) | A/160 oz + B/40 oz | A/160 oz + B/10 oz |

Agronomic and quality trait collection: Grain yield and yield quality traits (flour protein content, Grain protein content, flour yield, mix peak time, mix absorbance, baking volume) were determined.

Results

### Line IDO377512

### Agronomic and Quality Traits (Table 5)

There were no significant differences between the three treatments on grain yield, kernel weight or test weight. However, treatment with the combination of Composition A and Composition B provided higher grain and flour protein content than the untreated control. Baking and milling character were also improved in the treated groups (e.g. Baking volume, Mix water absorbance and Mixograph peak time) compared with the untreated control plot.

TABLE 5
Agronomic and quality traits that showed significant differences among
treatments for line IDO377S12

| Trait | Group^{a} | Treatment | Mean |
|---|---|---|---|
| Flour Protein | a | T2 | 15.23% |
| | ab | T1 | 14.35% |
| | b | Control | 13.1% |
| Grain Protein | a | T2 | 17.87% |
| | a | T1 | 17.11% |
| | b | Control | 15.35% |
| Mix peak time | a | T1 | 4.8 min |
| | ab | T2 | 4.3 min |
| | b | Control | 4.0 min |
| Mix water | a | T2 | 66% |
| Absorption | b | T1 | 64% |
| | b | Control | 63% |
| Baking volume | a | T1 | 1138 cm3 |
| | ab | T2 | 1100 cm3 |
| | b | Control | 1017 cm3 |

^{a}Treatments with the same letter do not have significant differences

### Line M12013

### Agronomic and Quality Traits (Table 6)

Those subjected to treatments of the combination of Composition A and Composition B had higher grain protein and flour protein content than the control, as well as better baking quality, as measured by mixograph peak time. There were no significant differences for kernel weight and test weight among the three treatments.

TABLE 6
Agronomic and quality traits that showed significant differences among
treatments for line M12013

| Trait | Group^{a} | Treatment | Mean |
|---|---|---|---|
| Flour Protein | a | T2 | 14.5% |
| | ab | T1 | 13.8% |
| | b | Control | 13.43% |
| Grain Protein | a | T2 | 16.96% |
| | b | T1 | 16% |
| | b | Control | 15.58% |
| Mix peak time | a | T2 | 5.0 min |
| | ab | T1 | 4.8 min |
| | b | Control | 4.2 min |

^{a}Treatments with the same letter do not have significant differences

Conclusions

To withstand drought conditions, wheat naturally produce higher level of protein in the grain. However, this higher protein content is frequently associated with reduced crop yield. We have unexpectedly found that application of a combination of Composition A and Composition B before flowering can further boost the protein levels without sacrificing the yield. Maintaining the total crop yield and also providing a higher protein content improves desired end-use quality characteristics, especially baking and milling quality for hard wheat.

### Example 3

### Effect of the Method to Prevent Quality Degradation of Turfgrass Subjected to Heat Stress

Conditions:

Turfgrass was treated with a combination of Composition A and Composition B and exposed to heat stress to determine whether application of the treatment provided any benefit. This study was carried out in a greenhouse under controlled environment.

Creeping bentgrass was grown in 3 inch plastic pots on LS#4 Sungrow soil mix at the University of Guelph greenhouse over a period 90 days. The grass pots were periodically watered, fertilized and cut to maintain a height of roughly 2 inches.

Prior to application, the turf pots were exposed to heat stress for 5 days. After acclimatization, the pots were sprayed with Composition A and Composition B or water (as untreated control).

The study was carried out at temperatures ranging from 30-35° C. Each treatment was sprayed and evaluated once a week for a period of three weeks. At the time of the first application, the turf quality had not succumbed to any degradation due to heat stress, as is shown in Table 7 below. Turf quality was rated based on uniformity, density and greenness.

The combination of Composition A and Composition B was applied weekly at 8 oz (Comp. A) and 0.5 oz (Comp. B) per 1000 square feet with the water volume about 2.3 gal/1000 ft2.

Results:

Turf quality was rated based on uniformity, density and greenness, using a scale rating of 0-10 where

For Uniformity/Density: 10 means very uniform and dense and 0 means significantly injured.

For Greeness: 10 means very green and 0 means yellowing throughout.

For Overall quality: 10 means no injury and 0 means significant injury.

As shown by the results in table 7 below, the method of applying the composition to the turf grass prior to the heat stress conditions and, in this example, during a period of heat stress, enhanced the tolerance of the turf to the stress conditions. In particular, the turf quality, in this example illustrated by way of measures of the uniformity, density, quality and greenness, was not degraded as quickly nor to the same extent as the control.

TABLE 7

| | Uniformity/density | quality | Greeness |
|---|---|---|---|
| | 0DAA | | |
| Control | 10 | 10 | 10 |
| Composition | 10 | 10 | 10 |
| A/Composition B/ | | | |
| | 8DAA | | |
| Control | 9 | 8.7 | 8.3 |
| Composition | 10 | 10 | 10 |
| A/Composition B/ | | | |
| | 15DAA | | |
| Control | 5.3 | 4.9 | 4.3 |
| Composition | 8 | 8.1 | 8.3 |
| A/Composition B/ | | | |
| | 21DAA | | |
| Control | 2 | 2 | 2 |
| Composition | 5.3 | 5.5 | 6 |
| A/Composition B/ | | | |

### Example 4

### Effect of a Combination of Composition a and Composition B on Excess Water Stress and Delayed Dormancy in Zoysia Grass

Materials and Methods

Zoysia grass is a type of warm season grass. Zoysia does not perform well in soil that was either under too much water or under drought conditions. Even without moisture or nutrient issues zoysia can have a comparatively yellowish green color during summer and especially displays its golden tan dormancy going into and coming out of winter. In this study, zoysia was exposed to three levels of moisture loss (0% Evapotranspiration (ET): wet condition, 50% ET, and 75% ET: drought condition), combined with three levels of nutrients (0.5 lb, 1 lb and 2 lb N/100 sq. ft).

A combination of Composition A and Composition B was applied every two to three weeks starting with spring greenup, April 20, in Carbondale, Ill. Zoysia (‘Meyer’) was maintained at a ¾-inch clip and soil moisture was applied at one inch per week to avoid physiologic drought stress through May and June to July 17. On July 18 fertilizer treatments (12-12-12 field grade fertilizer) were imposed @2, 1, and 0.5 lb N/1000 sq ft). The zoysia was allowed to respond to the fertilizer treatments for 10 days under similar soil moisture applications, at which point three levels of soil moisture (0, 50, and 75% ET) were imposed. Since the average daily ET rate for Southern Illinois in July and August is approximately ¼ inch, irrigation was applied to the entire experiment every day except Sunday at ¼ inch with the 50% ET block covered with a polyethylene plastic sheet during irrigation on Tuesdays, Thursdays, and Saturdays, while the 75% ET block was covered all days of irrigation except Monday. Otherwise, the 50 and 75 ET regimes were prevented from receiving any precipitation from July 16 to October 9. A quarter-inch rain on October 14 restored vegetative vigor and allowed the final turf quality rating on October 18.

Initial Shoot Density was recorded May 18 at the time when spring greenup was complete. This was two weeks after the first imposition of the ¾-inch clipping height and at the time of the second application of a combination of Composition A and Composition B. Each datum was the average of the live shoot counts of three 2.5-inch plugs within each experimental unit (plot). Shoot density was again recorded October 9, at the end of the experiment; one month after the last application of the combination of Composition A and Composition B and on the last day of moisture regime maintenance. The percent increase in shoot density was calculated by dividing the count from the recent date by that from the initial date.

Turf Quality ratings were recorded on September 10 before the onset of fall; then again on October 18 when temperatures had cooled enough to trigger the initial stage of fall hardening of zoysia toward dormancy. That is, older shoots and older leaves on mature shoots were turning yellow/brown and reducing turf quality.

The combination of Composition A and Composition B was applied at 16 oz of Comp. A and 1 oz. of Comp. B per 1000 square feet of zoysia grass.

Results and Discussion

In most cases, the combination of Composition A and Composition B improved the numbers quantifying shoot density, color, and turf quality.

Over all plots (Table 1), the combination of Composition A and Composition B have improved the percent increase in shoot density (292), and definitely improved color (7.0) and turf quality (7.4 and 7.7), especially during the cooling of October (7.7) when dormancy of zoysia grass normally starts. Treatment delayed the starting of dormancy of zoysiagrass

TABLE 8
Overall Zoysia response to treatments

| | Shoot Density | | | Color | Turf Quality | |
|---|---|---|---|---|---|---|
| | Dates | | | | | |
| | 5/18 | | % | | | |
| | (initial) | 10/9 | increase | 9/10 | 9/10 | 10/18 |
| None | 22.6 | 82.1 | 267 | 5.5 | 6.3 | 5.1 |
| Treated | 24.1* | 92.1* | 292 | 7.0** | 7.4** | 7.7** |
| Lsd | 1.7 | 10 | 57 | 0.5 | 0.2 | 0.5 |

*Significant at α = 0.1
**Significant α = 0.001

In Table 13, treatment with the combination of Composition A and Composition B significantly improved the turf color at either excess water stress (OET) or greatest drought stress (75ET) at the 2 lb. N/1000 sq. ft fertility level. For Zoysia grass, 50% ET represents optimal moisture level.

TABLE 13
Effects on Zoysia color (Sept 10) due to moisture level (2 lb. N/1000 ft²,
when fertilized in zoysia color on Sept. 10

| Fertility | | Moisture Regime | | |
|---|---|---|---|---|
| (lb N/M) | | 0 ET | 50% ET | 75% ET |
| 2.0 | No treatment | 7.0 | 7.3 | 6.2 |
| 2.0 | treatment (A + B) | 9.0* | 8.0 | 8.5* |

*Significant at Lsd (α = 0.05) = 1.5

Turf quality was the characteristic most enhanced by application of the combination of Composition A and Composition B; uniformity being the primary component of turf quality along with color and texture. Table 14 shows that the combination was very beneficial to turf quality in all moisture regimes including excess water conditions (0 ET) and nitrogen levels, on both dates. The greater degree of enhancements during October came from the delaying of the progression toward winter dormancy among the more mature leaves of the canopy, which was strongly breaking-up uniformity. Moisture regime at OET (excess of water) showed the most severe reduction on turf quality in October when the zoysia normally transition to dormancy period. Application of the combination of Compositions A and B extended the growing period of zoysia under the excess water stress condition.

TABLE 14
Effect of combination of Turf Quality under
different moisture regimes in zoysia

| | Moisture Regime | | | | | |
|---|---|---|---|---|---|---|
| | 0 ET | | 50% ET | | 75% ET | |
| | 9/10 | 10/18 | 9/10 | 10/18 | 9/10 | 10/18 |
| No Treatment | 6.6 | 4.2 | 6.3 | 5.1 | 6.0 | 6.1 |
| Treatment | 7.8* | 7.4* | 7.2* | 7.1* | 7.1* | 8.4* |

*significant on 9/10 Lsd (α = 0.05) = 0.4
*significant on 10/18 Lsd (α = 0.05) = 0.8

Conclusions

The experiment showed that the combination of Composition A and Composition B enhances zoysia tolerance to unfavorable moisture issues (i.e., reduced or excess water). In every interaction noted by the tables, a combination treatment can be found that provided better zoysia performance at a lower level of moisture. The combination treatment provides the option of improving zoysia turf color during summer and extending its color at a high level of uniformity into autumn and winter while enhancing its shoot density under moisture stress.

### Example 5

### Effect of a Combination of Composition a and Composition B on Delaying Winter Dormancy and Earlier Spring Green Up on Zoysiagrass

Materials and Methods

This experiment was conducted in Knoxville, Tenn., on a stand of ‘Royal’ zoysiagrass. Mowing was performed three times weekly at 0.625 in. with clippings recycled. The trial area was fertilized with urea (46-0-0) at a rate of 1.0 lb of nitrogen per 1000 ft² on 28 September and 15 October Individual plots measured 3 ft×10 ft and were arranged in a randomized complete block design with four replications. A two foot non-treated border was placed in-between replications to increase inoculum density surrounding the trial area. All treatments were applied at a spray volume of 2 gal/1000 ft² with a CO² powered backpack sprayer equipped with two TeeJet 8004VS nozzles at 26 psi. Treatments consisted of two spray applications in the fall. Fall applications were initiated 11 October and reapplied on 25 October. The 2^{nd} spray application on 25 October was administered two weeks after the first application instead of a 4 week interval due to a forecasted heavy frost in the immediate future and to ensure treatment uptake by the plant prior to winter dormancy. Percent green-up was visually estimated on 11 April.

Results

A combination of Composition A and Combination B applied to treat plots exhibited delayed dormancy as shown in the turf quality rating on November 30.

Due to cooler climatic conditions in March, spring green-up was delayed until mid-April. Differences in spring green-up were observed. Plots treated with (1) a combination of Composition A and Composition B; (2) treated with Heritage®; and (3) treated with a combination of Composition A and Composition B and with Heritage®; all exhibited faster green-up compared to the non-treated control. No phytotoxicity was observed throughout the duration of the trial period. Heritage® is a fungicide available from Syngenta.

| | | | | | Turf quality | |
|---|---|---|---|---|---|---|
| | | | | | at Nov 30 | % green |
| Treatment and rate per | | | | Application | (dormancy | up |
| 1000 ft² | | | | code^{y} | period) | (11 Apr) |
| 1 | Non-treated | | | | 1 | 45.0 |
| 2 | Comp. A | 16.0 | fl oz | AB^{y} | 6 | 57.5 |
| | Comp. B | 1.0 | fl oz | | | |
| 3 | Heritage ® | 0.4 | oz | AB | 3 | 60.8 |
| 4 | Heritage ® | 0.4 | oz | AB | 7 | 68.8 |
| | Comp. A | 16.0 | fl oz | | | |
| | Comp. B | 1.0 | fl oz | | | |

Conclusions

Treatment with a combination of Composition A and Composition B delays the transition to winter dormancy of zoysia grass. It also results in early spring green up. There is a synergism using a combination of Composition A and Composition B with a QoI fungicide on earlier greenup and delayed dormancy.

### Example 6

### Effect of a Combination of Composition a and Composition B on Transplant Shock in Tomato Plants

Materials and Methods:

This study was carried out with the primary purpose of treating bacterial spot and bacterial speck, Kocide 2000 (copper hydroxide 53.8%) was also included in a treatment with a combination of Composition A and Composition B.

Tomato transplants cultivar ‘H9909’ were transplanted on May 27 using a mechanical transplanter at a rate of 3 plants per metre. Each set of twin rows was spaced 1.5 m apart. Each treatment plot was 7 m long and consisted of one twin-row. The trial was setup as a randomized complete block design, with 4 replications per treatment. For treatments including a tray soak, transplant trays were placed left to absorb solution for either 2 or 8 hours on the day of transplanting, depending on the treatment. After soaking, the trays were removed from the solution and left on a rack to drip, and the leftover solution was measured. A 2-hour soak resulted in mean absorption of 2.60 to 3.82 ml per cell, whereas the 8-hour soak resulted in a mean absorption of 5.56 mL per cell. Foliar treatments were applied using a hand-held CO₂ sprayer (35 psi) with ULD 120-02 nozzles. Treatments were applied using 200 L of water Ha⁻¹ for the first four applications, and 300 L of water Ha⁻¹ for the final four applications. The trial was irrigated using a drip irrigation system as required during the growing season.

In addition to the primary endpoint of treatment of bacterial spot and bacterial speck, an unexpected observation related to transplant stunting was noted. Visual differences in plant size were observed among plants within the same row or plot in late June. The number of stunted plants per plot was counted on June 24.

Statistical analysis was conducted using ARM 7 (Gylling Data Management, Brookings, S. Dak.). Data were tested for normality using Bartlett's homogeneity of variance test. Analysis of variance was conducted using Duncan's new multiple range test and mean comparisons were performed when P≦0.05.

Results:

The number of stunted plants on June 24 was lower in all treatment groups that included a transplant tray soak with a combination of Composition A and Composition B on the day of transplanting than the number of stunted plants in the nontreated control group, Kocide 2000 treatment group, and the group that received foliar applications of Composition A and Composition B at the 1% v/v and 0.06% v/v application rate. Foliar applications of Composition A and Composition B at the 1% v/v+0.12% v/v rate also resulted in less stunting than the non-treated control.

None of the treatments caused any visual symptoms of phytotoxicity.

TABLE 1
Number of stunted tomato plants in plots treated with different products for
control of bacterial spot and bacterial speck, Ridgetown, ON, June 24.
I reformatted this table.

| Treatment (application timing)^{a} | |
|---|---|
| (#)^{b} | Stunted Plants |
| 1. Nontreated control | 5.0 a^{c} |
| 2. Kocide 2000 @ 3.2 kg Ha⁻¹ (A-H) | 3.1 ab |
| 3. Comp. A @ 5% v/v + Comp. B @ 5% v/v - 2 hr tray soak (A) | 0.3 c |
| 4. Comp. A @ 2% v/v + Comp. B @ 5% v/v - 2 hr tray soak (A) | 0.3 c |
| 5. Comp. A @ 5% v/v + Comp. B @ 5% v/v - 8 hr tray soak (A) | 0.6 c |
| 6. Comp. A @ 5% v/v + Comp. B @ 5% v/v - 2 hr tray soak (A) plus 496/A @ 1% v/v + 497/B @ | 0.0c |
| 0.06% v/v (B-J) | |
| 7. Comp. A @ 1% v/v + Comp. B @ 0.06% v/v (B-J) | 3.1 ab |
| 8. Comp. A @ 1% v/v + Comp. B @ 0.06% v/v + Kocide 2000 @ 3.2 kg Ha⁻¹ (B-J) | 3.4 ab |
| 9. Comp. A @ 1% v/v + Comp. B @ 0.12% v/v (B-J) | 1.2 bc |

^{a}A = May 27, B = June 3, C = June 11, D = June 17, E = June 24, F = July 1, G = July 8, H = July 15, I = July 22, J = July 29.
^{b}Data was transformed using a log transformation. The back-transformed means are shown here.
^{c}Numbers in a column followed by the same letter are not significantly different at P ≦ 0.05, Duncan's new multiple range test.
ns = not significant.

Conclusion

The results suggest that transplant treatments with a combination of Composition A and Composition B as a tray soak or foliar application or a combination thereof can increase plant resistance to the stress of transplant shock.

### Example 7

### Effect of Combination on Salt and Shade Tolerance of Turfgrass

Materials and Methods

Two trials were initiated in the greenhouse; one looking at the effect of a Composition C on Kentucky bluegrass grown under salt stress, and the other looking at the impact of Composition C on Kentucky bluegrass grown under low light conditions.

Salt study: Kentucky bluegrass seed was sown in potting soil in the greenhouse under full light approximately 4 weeks before the trial start date. Upon trial initiation on October 10^{th}, pots were watered with 0, 0.03, 0.06 0.09 or 0.12 M NaCl at a rate of 100 ml/pot, with additional applications occurring 1-2 times weekly thereafter. Half of the pots from each salt concentration were also treated with either a foliar application of water or the equivalent to 17 oz/1000 sq ft of COMPOSITION C at a rate of 100 gal/acre, with applications repeated every 14 days until November 21^{st} (treatments applied October 10, 24 and November 7, 21). Turf quality ratings (NTEP scale) were used to assess the effect of salt stress on overall turf health (Table 1) starting at trial initiation, and then repeated every two weeks thereafter.

Shade study: Kentucky bluegrass seed was sown in potting soil in the greenhouse under full light approximately 4 weeks before the trial start date. Upon trial initiation on October 10^{th}, pots were treated with foliar applications of water, or the equivalent to 4.25 oz, 8.5 oz, or 17 oz/1000 sq ft of COMPOSITION C at a rate of 100 gal/acre. Half of the pots per foliar treatment were then either placed back under full light, or covered with two layers of shade fabric (a third layer was added on October 30 as plants were not yet showing signs of low light stress). Subsequent applications of the foliar treatments were applied every 14 days until November 21^{st} (treatments applied October 10, 24 and November 7, 21). Turf quality ratings (NTEP scale) were used to assess the effect of lighting conditions on overall turf health (Table 2) starting at trial initiation, and then repeated every two weeks thereafter.

Results

Salt study: Turf grass did not shown significant sign of stress during the first two applications and no significant difference between the treatments. Turf quality ratings shown in Table 1 highlight results assessed 35 days after initial foliar applications (7 days after 3^{rd} application) or 49 days after initial foliar applications (7 days after 4^{th} application), as these were the dates when the greatest differences were observed between COMPOSITION C treated and water treated plants.

TABLE 1
Salt Stress Study

| | Turf Quality² - 35 d after | | Turf Quality - 49 d after | |
|---|---|---|---|---|
| Salt | initial treatment | | initial treatment | |
| Treatment | Water | <<COMPOSITION | Water | <<COMPOSITION |
| (NaCl)¹ | treated³ | C>> treated³ | treated | C>> treated |
| 0M | 7.3 | 8.8 | 6 | 9 |
| (water) | | | | |
| 0.03M | 6.3 | 8 | 5 | 8.3 |
| 0.06M | 5 | 7.5 | 3.5 | 7.8 |
| 0.09M | 4.8 | 6.8 | 3 | 7.8 |
| 0.12M | 5.8 | 6.3 | 5 | 5.3 |

¹Salt solutions were watered into each pot at a rate of 100 ml/pot, 1-2 times weeky.
²Ratings were based on NTEP scale (1-9), where 6 = minimally acceptable turf, and 9 = excellent turf quality.
³Plants were treated with water at a rate of 100 gal/acre.
⁴Plants were treated with the equivalent to 17 oz/1000 sq ft COMPOSITION C at a rate of 100 gal/acre.

Shade study: Turf grass did not shown significant sign of stress during the first two applications and no significant difference between the treatments. Turf quality ratings shown in Table 2 highlight results assessed 35 days after initial foliar applications (7 days after 3^{rd} application) or 49 days after initial foliar applications (7 days after 4^{th} application), as these were the dates when the greatest differences were observed between COMPOSITION C and water treated plants.

TABLE 2
Low Light Study

| | Turf Quality² - 35 d after | | Turf Quality - 49 d after | |
|---|---|---|---|---|
| COMPOSITION C | initial treatment | | initial treatment | |
| Treatment¹ | Shade³ | Full Light⁴ | Shade | Full Light |
| 0 oz/1000 sq ft | 6.5 | 8.5 | 5 | 7.5 |
| (water) | | | | |
| 4.25 oz/1000 sq ft | 7.8 | 8.0 | 6.8 | 8.5 |
| 8.5 oz/1000 sq ft | 7.8 | 9 | 7.8 | 9 |
| 17 oz/1000 sq ft | 8 | 9 | 8 | 9 |

¹Treatments were applied at a rate of 100 gal/acre.
²Ratings were based on NTEP scale (1-9), where 6 = minimally acceptable turf, and 9 = excellent turf quality.
³Plants were placed under two layers of shade fabric on October 10, followed by a third layer on October 30.
⁴Plants were left in full light for duration of experiment.

Conclusions

The method of applying the composition to the turf grass at the onset of the salt or shade stress conditions, enhanced the tolerance of the turf to the stress conditions. In particular, the turf quality, was not degraded as quickly nor to the same extent as the control.

### Example 8

### Effect of a Combination on Salt Tolerance on Spring Wheat

Materials and Methods

Salt stress study was initiated on spring wheat in the greenhouse. Wheat seeds were grown in the greenhouse under full light for 2 to 3 weeks to reach the 3-leaf stage. The wheat plants were treated with Composition A and Composition B by foliar application with a total spray volume of 100 gal/acre. Salt stress was introduced 24 hrs later by drenching of a 150 ppm NaCl solution into each pot (500 mL solution/pot). A second salt solution was applied 1 week later. The plant continued to grow for 2 additional weeks before the plant height and biomass data (fresh and dry weight) were measured.

The treatments were performed as follows:

#1. Untreated control under Salt stress;
#2. Salt stress with application of 5% Composition A and 0.312% of Composition B;
#3. Salt stress with application of 5% Composition A and 0.625% of Composition B;
#4. Salt stress with application of 5% Composition A and 1.25% of Composition B; and
#5. Untreated control without salt stress (normal condition).

Results

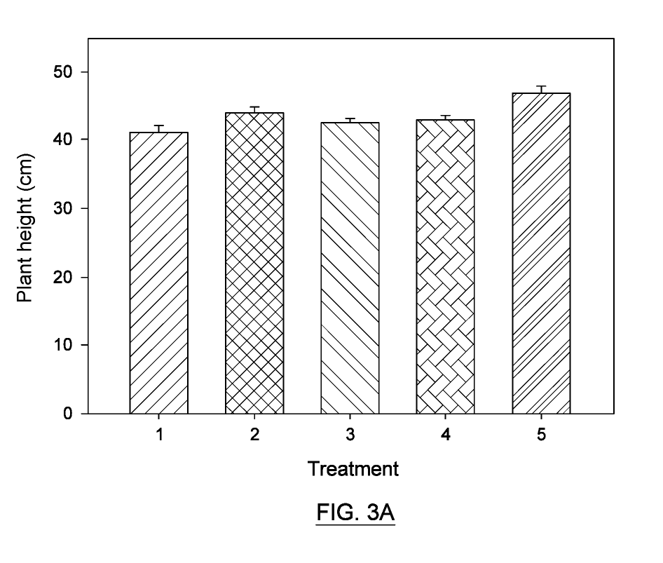

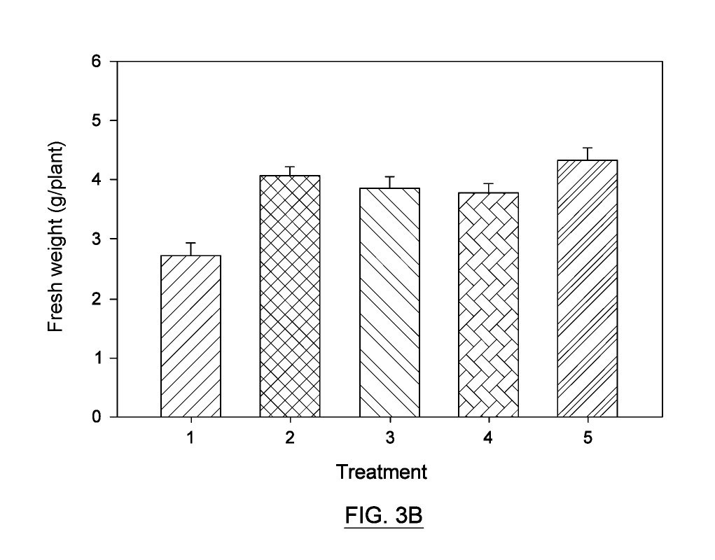

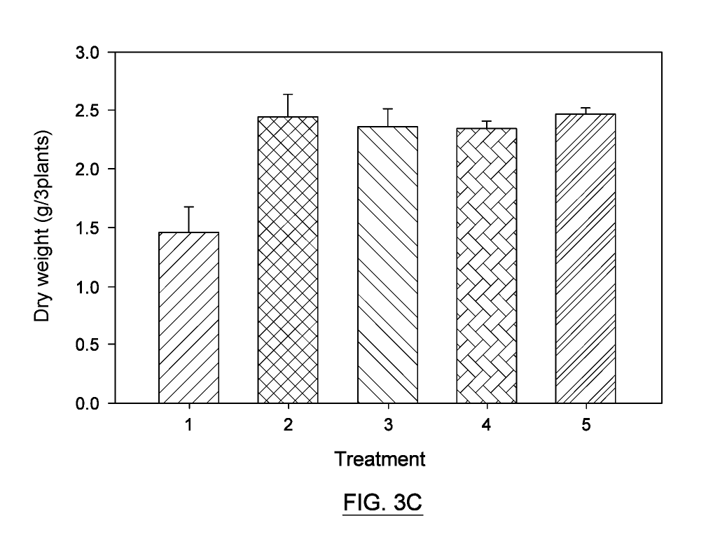

The plant height for each treatment is shown in FIG. 3A. There was no significant difference on plant height.

The biomass (above ground) was measured for each treatment by fresh weight (FIG. 3B) and dry weight (FIG. 3C). The plants treated with Composition A and Composition B exhibited higher dry weight and fresh weight compared with untreated control under salt stress. The treated plant under salt stress also exhibited similar biomass as an untreated control which was not subjected to salt stress.

Although various implementations of the invention are disclosed herein, many adaptations and modifications can be made within the scope of the invention in accordance with the common general knowledge of those skilled in this art. Such modifications include the substitution of known equivalents for any aspect of the invention in order to achieve the same result in substantially the same way.

Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein.

The invention includes all implementations and variations substantially as hereinbefore described and with reference to the examples. Other implementations are within the scope of the following claims.

What is claimed is:

1. A method for increasing resistance of a plant to one or more abiotic stresses, which comprises applying an agriculturally effective amount of a combination to the plant, the combination comprising:
a paraffinic oil;
an emulsifier;
a pigment; and
water;
wherein an abiotic stress is a stress chosen from: cold stress, heat stress, water stress, transplant shock stress, low light stress and salinity stress.

2. The method of claim 1, wherein the combination is applied to the plant at or before onset of the abiotic stress.

3. The method of claim 2, wherein the combination is additionally applied to the plant after onset of the abiotic stress.

4. The method of any one of claims 1 to 3, wherein the combination is applied to the plant by soil drenching.

5. The method of any one of claims 1 to 3, wherein the combination is applied to the plant by foliar application.

6. The method of any one of claims 1 to 3, wherein the combination is applied to the plant by soil drenching and foliar application.

7. The method of any one of claims 1 to 6, wherein the combination further includes a silicone surfactant.

8. A method for increasing resistance of a plant to damage caused by cold stress, which comprises applying an agriculturally effective amount of a combination to the plant, the combination comprising:
a paraffinic oil;
an emulsifier;
a pigment; and
water.

9. The method of claim 8, wherein the combination further includes a silicone surfactant.

10. The method of any one of claim 8 or 9, wherein:
the plant is a plant that is hardy in a first hardiness zone at temperatures between a first minimum temperature and a first maximum temperature; and
increasing resistance of the plant to cold stress comprises increasing hardiness of the plant to temperatures below the first minimum temperature.

11. The method of any one of claims 8 to 10, wherein:
the plant is a tree; and
increasing resistance of the plant to damage comprises increasing cold hardiness of the plant by about 2 to about 4 degrees Celsius.

12. The method of any one of claims 8 to 11, wherein the plant is a fruit-bearing tree.

13. The method of any one of claims 8 to 11, wherein the plant is an apple tree.

14. The method of any one of claims 8 to 11, wherein then plant is a peach tree.

15. The method of any one of claims 8 to 14, wherein the combination is applied to the plant before onset of the cold stress.

16. The method of any one of claims 8 to 15, wherein the combination is applied at onset or during the onset of cold stress.

17. The method of any one of claims 8 to 14, wherein:
the cold stress is a late frost that occurs after budding of the plant; and
the combination is applied prior to budding of the plant.

18. The method of any one of claims 8 to 17, wherein increased resistance of the plant to cold stress comprises a delayed onset of dormancy of the plant.

19. The method of any one of claims 8 to 14, wherein:
the cold stress is an early frost that occurs before dormancy of the plant; and
the combination is applied prior to onset of the early frost.

20. The method of any one of claims 8 to 14, wherein:
the cold stress is a winter season during dormancy of the plant; and
the combination is applied prior to dormancy of the plant.

21. A method for increasing resistance of a plant to damage caused by drought stress, which comprises applying an agriculturally effective amount of a combination to the plant, the combination comprising:
a paraffinic oil;
an emulsifier;
a pigment; and
water;
wherein the plant is not a turfgrass.

22. The method of claim 21, wherein the combination further includes a silicone surfactant.

23. The method of claim 21 or 22, wherein the combination is applied to the plant before onset of the drought stress.

24. The method of any one of claims 21 to 23, wherein the combination is applied to the plant at onset or during the onset of the drought stress.

25. The method of any one of claims 21 to 23, wherein the combination is applied to the plant 1 to about 10 times prior to onset of the drought stress.

26. The method of any one of claims 21 to 25, wherein:
the plant comprises a wheat plant; and
increasing resistance of the plant to drought stress comprises increasing protein yield in the wheat plant after being subjected to the drought stress as compared to before the drought stress.

27. The method of any one of claims 21 to 26, wherein:
the combination is applied by soil drenching and/or foliar application at a flag leaf stage and at a flowering stage.

28. The method of any one of claims 21 to 26, wherein:
the combination is applied by soil drenching and/or foliar application at least once prior to a flowering stage.

29. A method for increasing resistance of a plant to damage caused by heat stress, which comprises applying an agriculturally effective amount of a combination to the plant, the combination comprising:
a paraffinic oil;
an emulsifier;
a pigment; and
water.

30. The method of claim 29, wherein the combination further includes a silicone surfactant.

31. The method of claim 29 or 30, wherein:
the plant is a plant that is hardy in a first hardiness zone at temperatures between a first minimum temperature and a first maximum temperature; and
increasing resistance of the plant to damage comprises increasing hardiness of the plant to temperatures above the first maximum temperature.

32. The method of any one of claims 29 to 31 wherein the combination is applied to the plant before onset of the heat stress.

33. The method of any one of claims 29 to 31, wherein the combination is applied to the plant 1 to about 10 times before onset of the heat stress.

34. The method of any one of claims 29 to 33, wherein the combination is applied at onset or during the heat stress.

35. The method of any one of claims 29 to 34, wherein:
the plant is a turfgrass plant; and
increasing resistance of the plant comprises reducing degradation in quality of the turfgrass caused by the heat stress as compared to untreated turfgrass subjected to the heat stress.

36. The method of claim 35, wherein reducing degradation in quality comprises reducing degradation in colour of the turfgrass.

37. The method of claim 35, wherein reducing degradation in quality comprises reducing degradation in shoot density of the turfgrass.

38. A method for increasing resistance of a plant to damage caused by salinity stress, which comprises applying an agriculturally effective amount of a combination to the plant, the combination comprising:
a paraffinic oil;
an emulsifier;
a pigment; and
water.

39. The method of claim 38, wherein the combination further includes a silicone surfactant.

40. The method of claim 38 or 39, wherein the combination is applied to the plant before onset of the salinity stress.

41. The method of claim 40, wherein the combination is applied to the plant 1 to about 10 times before onset of the salinity stress.

42. The method of any one of claims 38 to 41, wherein the combination is applied at onset or during the salinity stress.

43. The method of any one of claims 38 to 42, wherein:
the plant is a turfgrass plant; and
increasing resistance of the plant comprises reducing degradation in quality of the turfgrass caused by the salinity stress as compared to untreated turfgrass subjected to the salinity stress.

44. A method for increasing resistance of a plant to damage caused by low light stress, which comprises applying an agriculturally effective amount of a combination to the plant, the combination comprising:
a paraffinic oil;
an emulsifier;
a pigment; and
water.

45. The method of claim 44, wherein the combination further includes a silicone surfactant.

46. The method of claim 44 or 45, wherein:
the low light stress is a periodic problem; and
the combination is applied to the plant before onset of a period of low light stress.

47. The method of claim 46, wherein the combination is applied to the plant 1 to about 10 times before onset of the period of low light stress.

48. The method of any one of claims 44 to 47, wherein the combination is applied at onset or during the period of low light stress.

49. The method of any one of claims 44 to 48, wherein:
the plant is a turfgrass plant; and
increasing resistance of the plant comprises reducing degradation in quality of the turfgrass caused by the low light stress as compared to untreated turfgrass subjected to the low light stress.

50. A method for decreasing a dormancy period of a plant, which comprises applying an agriculturally effective amount of a combination to the plant, the combination comprising:
a paraffinic oil;
an emulsifier;
a pigment; and
water.

51. The method of claim 50, wherein the combination further includes a silicone surfactant.

52. The method of claim 50 or 51, wherein the combination is applied to the plant prior to the onset of dormancy.

53. The method of any one of claims 50 to 52, wherein the combination is applied to the plant during dormancy.

54. A method for increasing resistance of a plant to damage caused by one or more abiotic stresses, which comprises applying an agriculturally effective amount of a combination to the plant, the combination comprising:
a paraffinic oil;
an emulsifier;
a pigment; and
water;
wherein the plant is not a turfgrass.

55. The method of claim 54, wherein the combination further includes a silicone surfactant.

56. A method for increasing resistance of a plant to one or more abiotic stresses, which comprises applying an agriculturally effective amount of a combination to the plant, the combination comprising:
a paraffinic oil;
an emulsifier;
a pigment;
a silicone surfactant; and
water;
wherein the plant is not a turfgrass.

57. A method for increasing resistance of a plant to one or more abiotic stresses, which comprises applying an agriculturally effective amount of a combination to the plant, the combination comprising:
a paraffinic oil;
an emulsifier;
a pigment;
a silicone surfactant; and
water;
wherein an abiotic stress is a stress chosen from: cold stress, heat stress, water stress, transplant shock stress, low light stress and salinity stress.

58. A method for increasing resistance of a plant to damage caused by transplant shock stress, which comprises applying an agriculturally effective amount of a combination to the roots of the plant, the combination comprising:
a paraffinic oil;
an emulsifier;
a pigment; and
water.

59. The method of claim 58, wherein the combination further includes a silicone surfactant.

60. The method of claim 58 or 59, wherein the combination is applied at onset or during the period of the transplant.

61. The method of any one of claims 58 to 60, wherein:
the plant is a tomato plant; and
increasing resistance of the plant comprises preventing or reducing stunting of growth of the plant caused by the transplant shock stress as compared to an untreated tomato plant subjected to the transplant shock stress.

62. A method for increasing resistance of a plant to damage caused by water stress, which comprises applying an agriculturally effective amount of a combination to the plant, the combination comprising:
a paraffinic oil;
an emulsifier;
a pigment; and
water.

63. The method of claim 62, wherein the combination further includes a silicone surfactant.

64. The method of claim 62 or 63, wherein the combination is applied to the plant before onset of the water stress.

65. The method of claim 64, wherein the combination is applied to the plant 1 to about 10 times before onset of the water stress.

66. The method of any one of claims 62 to 65, wherein the combination is applied at onset or during the water stress.

67. The method of any one of claims 62 to 66, wherein:
the plant is a turfgrass plant; and
increasing resistance of the plant comprises reducing degradation in quality of the turfgrass caused by the water stress as compared to untreated turfgrass subjected to the water stress.

68. The method according to any one of claims 1-7, 8-10, 15-20, 29-34, 38-42, 44-48, 50-53, 57-60 or 62-66, wherein the plant is a non-woody crop plant, a turfgrass or a woody plant.

69. The method according to any one of claims 1-7, 8-10, 15-25, 29-34, 38-42, 44-48, 50-53, 57-60 or 62-66, wherein the plant is a non-woody plant or a woody plant but is not a turfgrass.

70. The method according to any one of claims 1-7, 8-10, 15-20, 29-34, 38-42, 44-48, 50-53, 57-60 or 62-66, wherein the plant is a tree.

71. The method of any one of claim 70, wherein the tree is a maple tree, a citrus tree, an apple tree, a pear tree, a peach tree, a cherry tree, an oak tree, an ash tree, a pine tree, or a spruce tree, a shrub or any combination thereof.

72. The method of any one of claims 1-3, 7-57 or 62-67, wherein the combination is applied by soil drenching.

73. The method of any one of claims 1-3, 7-57 or 62-67, wherein the combination is applied by foliar application.

74. The method of any one of claims 1-3, 7-57 or 62-67, wherein the combination is applied by soil drenching and foliar application.

75. The method according to any one of claims 1 to 74, wherein the combination is applied diluted in water at a rate of about 0.1 to about 75 oz/1000 square feet.

76. The method according to any one of claims 1 to 75, wherein the paraffinic oil comprises a paraffin having from 16 carbon atoms to 35 carbon atoms.

77. The method according to any one of claims 1 to 76, wherein the paraffinic oil has a paraffin content of at least about 80%.

78. The method according to any one of claims 1 to 76, wherein the paraffinic oil comprises synthetic isoparaffins.

79. The method according to any one of claims 1 to 77, wherein the composition comprises a paraffinic oil-in-water emulsion.

80. The method according to any one of claims 1 to 79, wherein the weight ratio of the paraffinic oil to the emulsifier is from about 5:1 to about 500:1.

81. The method according to any one of claims 1 to 80, wherein the weight ratio of the paraffinic oil to the emulsifier is about 50:1.

82. The method according to any one of claims 1 to 81, wherein the emulsifier comprises a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or a composition thereof.

83. The method according to any one of claims 1 to 82, wherein the emulsifier comprises a natural or synthetic alcohol ethoxylate.

84. The method according to any one of claims 1 to 83, wherein the pigment is a copper phthalocyanine.

85. The method according to any one of claims 1 to 84, wherein the weight ratio of the paraffinic oil to the pigment is from about 1:5 to about 100:1.

86. The method according to any one of claims 1 to 85, wherein the weight ratio of the paraffinic oil to the pigment is about 30:1.

87. The method according to any one of claims 1 to 86, wherein the pigment is a water-based pigment dispersion.

88. The method according to any one of claims 1 to 87, wherein the pigment is an oil-based pigment dispersion.

89. The method according to any one of claims 1 to 88, wherein the combination further includes a silicone surfactant, and the silicone surfactant is a silicone polyether.

90. The method according to any one of claims 1 to 89, wherein the combination further includes a silicone surfactant, and the silicone surfactant comprises a polyethylene glycol according to formula IV:
R¹—O—(CH₂CH₂O)_{f}—R²
wherein R¹=H or CH₂═CH—CH₂ or COCH₃; R²=H or CH₂═CH—CH₂ or COCH₃; and f≧1.

91. The method according to any one of claims 1 to 90, wherein the combination further includes a silicone surfactant, and wherein the weight ratio of the pigment to the silicone surfactant is from about 2:1 to about 50:1.

92. The method according to any one of claims 1 to 91, wherein the composition further comprises an anti-settling agent.

93. The method according to any one of claims 1 to 92, wherein the composition further comprises a plant growth regulator.

94. The method according to any one of claims 1 to 93, wherein the composition further comprises a QoI or DMI fungicide
